(19) United States
(12) Patent Application Publication
(10) Pub. No.: US 2005/0136364 A1
(43) Pub. Date: Jun. 23, 2005

(54) Stable developer dispersions for color photothermographic systems

(75) Inventors: David H. Levy, Rochester, NY (US); Mary C. Brick, Webster, NY (US); Jared B. Mooberry, Rochester, NY (US); Wojciech K. Slusarek, Rochester, NY (US); James H. Reynolds, Rochester, NY (US); Steven Evans, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 10/744,542

(22) Filed: Dec. 22, 2003

(51) Int. Cl. G03C 5/18

(52) U.S. Cl. 430/464

(57) ABSTRACT

Solid particle dispersions of blocked developers useful in imaging elements can be made with substantially improved stability to particle growth by dispersing the blocked developer of interest in the presence of a relatively small amount of an additional blocked developer that is structurally similar to the main blocked developer of interest. This additional blocked developer can be combined with the main blocked developer of interest prior to dispersing the main blocked developer of interest, i.e., prior to milling in the case of milled dispersions, and prior to precipitation in the case of pH or solvent precipitated dispersions.

### FIELD OF THE INVENTION

This invention relates to an imaging element containing stable dispersions comprising blocked developing agents, a process of making such dispersions, and imaging elements containing such dispersions.

### BACKGROUND OF THE INVENTION

In conventional color photography, films containing light-sensitive silver halide are employed in hand-held cameras. Upon exposure, the film carries a latent image that is only revealed after suitable processing. These elements have historically been processed by treating the camera-exposed film with at least a developing solution having a developing agent that acts to form an image in cooperation with components in the film. Developing agents commonly used are reducing agents, for example, p-aminophenols or p-phenylenediamines.

Typically, developing agents (also herein referred to as developers) present in developer solutions are brought into reactive association with exposed photographic film elements at the time of processing. Segregation of the developer and the film element has been necessary because the incorporation of developers directly into sensitized photographic elements can lead to desensitization of the silver halide emulsion and undesirable fog. Considerable effort, however, has been directed to producing effective blocked developing agents (also referred to herein as blocked developers) that might be introduced into silver halide emulsion elements without deleterious desensitization or fog effects. Accordingly, blocked developing agents have been sought that would unblock under preselected conditions of development after which such developing agents would be free to participate in image-forming (dye or silver metal forming) reactions.

Challenges to obtaining effective and improved blocked developers have included the following problems: desensitization of sensitized silver halide; unacceptably slow unblocking kinetics; instability of blocked developer yielding increased fog and/or decreased Dmax after storage; lack of simple methods for releasing the blocked developer; inadequate or poor image formation; and other problems. Especially in the area of photothermographic color films, other potential problems include poor discrimination and poor dye-forming activity.

Recent developments in blocking and switching chemistry have led to blocked developing agents, including p-phenylenediamines, that perform relatively well. In particular, commonly assigned co-pending U.S. patent application Ser. No. 09/614,035; and U.S. Pat. Nos. 6,440,618 and 6,319,640 disclose a blocked compound that decomposes (i.e., unblocks) on thermal activation by a 1,2 elimination mechanism. In particular, in the latter application, a blocked group comprises a sulfonyl group attached to a 6-membered heteroaromatic group.

There remains a need for blocked photographically useful compounds with good keeping properties, which at the same time exhibit good unblocking kinetics. With respect to developing agents, it is an object to obtain a film incorporating blocked developing agents that provide good dye-forming activity and which, at the same time, yield little or no increased fog and/or provide little or no decrease in Dmax after storage.

Substantially water-insoluble compounds useful in imaging are commonly incorporated into imaging elements in the form of aqueous coated layers of such imaging materials as dispersions or emulsions. In many cases, the compound useful in imaging is dissolved in one or more organic solvents, and the resulting oily liquid is then dispersed into an aqueous solution containing, optionally, dispersing aids such as surfactants and/or hydrophilic colloids such as gelatin. Dispersal of the oily liquid into the aqueous medium is accomplished using high shearing rates or high turbulence in devices such as colloid mills, ultrasonicators, or homogenizers.

In the art of dispersion making, the use of organic solvents has traditionally been considered necessary to achieve small particle sizes, to achieve stable dispersions, and to achieve the desired reactivity of the compound useful in imaging. Some compounds that might be useful in imaging cannot be dispersed in the above manner, however, because of their poor solubility in most organic solvents. In other cases, the compound of interest may have sufficient solubility in organic solvents, but it may be desirable to eliminate the use of the organic solvent to reduce the attendant adverse effects, for example, to reduce coated layer thickness, to reduce undesirable interactions of the organic solvent with other materials in the imaging element, to reduce risk of fire or operator exposure in manufacturing, or to improve the sharpness of the resulting image.

The incorporation of blocked developers in photographic elements is typically carried out using colloidal gelatin dispersions of the blocked developers. These dispersions are prepared using means well known in the art, wherein the developer precursor is dissolved in a high vapor pressure organic solvent (for example, ethyl acetate), along with, in some cases, a low vapor pressure organic solvent (such as dibutylphthalate), and then emulsified with an aqueous surfactant and gelatin solution. After emulsification, usually done with a colloid mill, the high vapor pressure organic solvent is removed by evaporation or by washing, as is well known in the art. Alternatively, solid particle (ball-milled) dispersions can be prepared using means well known in the art, typically by shaking a suspension of the material with zirconia beads and a surfactant in water until sufficiently small particle size is produced.

Techniques for making solid particle dispersions, however, are very different from the techniques used to make dispersions of oily liquids. Solid particle dispersions of compounds useful in imaging may be conventionally made by mixing a crystalline solid of interest with an aqueous solution that may contain one or more stabilizers or grinding aids. Particle size reduction is accomplished by subjecting the solid crystals in the slurry to repeated collisions with beads of hard milling media, such as sand, spheres of silica, stainless steel, silicon carbide, glass, zirconium, zirconium oxide, alumina, titanium, etc., which fracture the crystals. Polymeric milling media, such as polystyrene beads, may also be used as described in copending, commonly assigned U.S. Pat. No. 5,478,705. The conventional milling media bead sizes typically range from 0.25 to 3.0 mm in diameter. Smaller milling media having a mean particle size less than 100 microns may also be used as described in copending, commonly assigned U.S. Pat. No. 5,500,331. Ball mills, media mills, attritor mills, jet mills, vibratory mills, etc. are frequently used to accomplish particle size reduction. These methods are described, e.g., in U.S. Pat. Nos. 4,006,025; 4,294,916; 4,294,917; 4,940,654; 4,950,586; and 4,927,744; and UK 1,570,362.

Solid particle dispersions of compounds useful in imaging can also be made conventionally by precipitation techniques, e.g., where a compound of interest is dissolved in an aqueous solution at high pH, together with appropriate surfactants and polymers, and subsequently precipitated by lowering the pH of the solution. These methods are described, e.g., in GB 1,131,399, and U.S. Pat. Nos. 5,279,931; 5,158,863; 5,135,844; 5,091,296; 5,089,380; 5,013,640; 4,990,431; 4,970,139; 5,256,527; 5,015,564; 5,008,179; and 4,957,857. Another known method of precipitation involves dissolving the compound useful in imaging in a water-miscible organic solvent and subsequently mixing this solution with water containing appropriate stabilizers to cause precipitation of the compound and formation of the solid particle dispersion. These methods are described, e.g., in U.S. Pat. No. 2,870,012.

Unfortunately, solid particle dispersions made by the grinding or precipitation techniques described above are frequently subject to unwanted particle growth, either in the solid particle dispersion itself, or when the dispersion is mixed with other materials useful in imaging prior to coating onto a support. In particularly bad cases, particle growth may result in the formation of long, needle-like crystals of the compound of interest. Such particle growth is undesirable, e.g., as it reduces the covering power of the developing agent. The presence of needle-like crystals is also undesirable, as they result in filter plugging and poor manufacturability.

Unwanted particle growth in solid particle dispersions of compounds useful in imaging can be improved by various techniques, including using fluorinated surfactants as grinding aids as described in U.S. Pat. No. 5,300,394; employing certain hydrophobic, water-soluble polymers as grinding aids for solid particle dispersions of filter dyes and thermal transfer dyes as disclosed in copending, commonly assigned U.S. Pat. No. 5,468,598; adding water soluble polymers such as polyvinylpyrrolidone to solid particle dispersions of sensitizing dyes to reduce particle or crystal growth, as described in U.S. Pat. No. 4,006,025.

U.S. Pat. No. 5,750,323 to Scaringe et al. found that solid particle dispersions of compounds useful in imaging elements can be made with substantially improved stability to particle growth by dispersing the compound of interest in the presence of a minor amount of a second compound that is structurally similar to the compound of interest. This second compound is combined with the compound of interest prior to dispersing the compound of interest, i.e., prior to milling in the case of milled dispersions, and prior to precipitation in the case of pH or solvent precipitated dispersions. While being distinct, the second compound has a similar chemical structure to the main compound. More specifically, the second compound and first compound each comprise an identical structural section thereof which makes up at least 75% of the total molecular weight of the main compound, while the structurally similar second compound has at least one substituent bonded to the identical portion common with the first compound which has a molecular weight higher than the corresponding substituent of the first compound. In column 6, lines 64-65, Scaringe states that such compound can be a silver halide developing agent.

Flocculation in pigmentary dispersions of phthalocyanine derivatives used for printing inks has been controlled by milling the pigment in the presence of a second phthalocyanine derivative containing a nitrogen-bearing substituent, as described in U.S. Pat. No. 5,279,654.

The prior art does not disclose the preparation of a solid particle dispersion of a blocked developer to overcome instability problems in an imaging element, especially in a photothermographic film.

### PROBLEMS TO BE SOLVED

It would be desirable to provide increased control over undesirable particle growth of solid particles in a dispersion of a blocked developer useful in imaging elements. Crystal growth in the blocked developer dispersions leads to reduced activity, coating defects and undesired viscosity increases in the coating melts. Accordingly, it is an object of the present invention to provide a method for making solid-particle dispersions of blocked developers useful in imaging elements that are stable to particle growth or particle ripening.

### SUMMARY OF THE INVENTION

Applicants have found that solid particle dispersions of blocked developers useful in imaging elements can be made with substantially improved stability to particle growth by dispersing the blocked developer of interest in the presence of a minor amount of a second blocked developer that is structurally similar to the blocked developer of interest.

Preferably, this second blocked developer is combined with the blocked developer of interest prior to dispersing the blocked developer of interest, i.e., prior to milling in the case of milled dispersions, and prior to precipitation in the case of pH or solvent precipitated dispersions. While being distinct, the second blocked developer has a similar chemical structure to the main blocked developer. The second blocked developer and first blocked developer each comprise an identical structural section thereof which makes up at least 75% of the total molecular weight of the main blocked developer.

In particular, the present invention relates a process for preparing a solid particle aqueous dispersion of a first blocked developer useful in imaging elements comprising: (a) adding a structurally similar distinct additive in the form of a second blocked developer, to the first blocked developer, and (b) dispersing the first blocked developer and second blocked developer together in an aqueous medium; wherein both the first blocked developer and the second blocked developer independently have the following Structure I:
DEV-(LINK 1)ₗ-(TIME)ₘ-(LINK 2)ₙ-B I
wherein,

DEV is a phenylene diamine moiety as defined below which when released forms a color developing agent:

LINK 1 and LINK 2 are linking groups;

TIME is a timing group;

l is 0or 1;

m is 0, 1, or 2;

n is 0 or 1;

l+n is 1 or 2;

B comprises a second phenylene diamine moiety DEV and is represented by the following structure:
-B′-(LINK 2)ₙ-(TIME)ₘ-(LINK 1)ₗ-DEV
wherein B′ is a common blocking group for both DEV moieties;

wherein DEV in the second blocked developer is independently represented by the following structure: 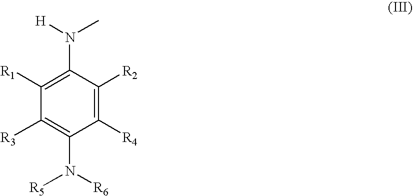
wherein R₁, R₂, R₃, R₄, R₅ and R₆ which can be the same or different are individually H, alkyl, substituted alkyl, alkenyl, substituted alkenyl, aryl, substituted aryl, halogen, cyano, hydroxy, alkoxy, substituted alkoxy, aryloxy, substituted aryloxy, amino, substituted amino, alkylcarbonamido, substituted alkylcarbonamido, arylcarbonamido, substituted arylcarbonamido, alkylsulfonamido, arylsulfonamido, substituted alkylsulfonamido, substituted arylsulfonamido, or sulfamyl or wherein at least two of R₁, R₂, R₃, R₄, R₅ and R₆ together further form a substituted or unsubstituted carbocyclic or heterocyclic ring structure or wherein R₅ or R₆ can optionally form a fused ring with R₃ or R₄, respectively on the phenylene ring; and

wherein the first blocked developer independently is represented by Structure III except that R₅ is the same as R₆ and both are alkyl groups.

In particular, it has been found that a mixture of the two blocked developers prevents the formation of undesirable crystals, which otherwise would occur by using only the blocked developer present in the greater amount, when the DEV in the first blocked developer (which can be the main blocked developer) is the same as the DEV in the second blocked developer except either (a) differs with respect to R₅ and/or R₆ and/or (b) differs by the number of carbons in any one or more substituents R₁, R₂, R₃, R₄ on the phenylene ring in Structure III.

One aspect of this invention comprises a process for preparing a solid particle aqueous dispersion of a first blocked developer useful in imaging elements, including photothermographic elements.

Another aspect of this invention comprises a stable solid particle dispersion comprising solid particles of a first blocked developer useful in imaging elements and a structurally similar distinct additive in the form of a second blocked developer as defined above co-dispersed in an aqueous medium.

In a preferred embodiment, the blocked developer that decomposes (i.e., unblocks) on thermal activation by a 1,2 elimination mechanism to release a color developing agent. In this embodiment, thermal activation preferably occurs at temperatures between about 100 and 180° C. Alternatively, thermal activation can occur at temperatures between about 20 and 140° C. in the presence of added acid, base and/or water.

With our invention, aqueous solid particle dispersions of blocked developers useful in imaging which are subject to undesirable particle growth can be made more quickly (i.e., with faster rates of particle size reduction), or with smaller particle size, and with vastly improved stability to particle and needle growth relative to prior art solid particle dispersions made in the absence of the additive.

### DETAILED DESCRIPTION OF THE INVENTION

As indicated above, it has been found that mixing a blocked developer useful in imaging elements with a distinct, but structurally similar additive in the form of a second blocked developer prior to dispersal in an aqueous medium results in solid particle dispersions that are substantially more stable to particle growth than similar dispersions made without such additives. The structurally similar additives are structurally distinct from the main blocked developer of interest, while containing an identical portion comprising at least 75%, preferably more than 90% of the chemical structure on a molecular weight basis of the main blocked developer of interest. By having at least 75% of the same chemical structure, we mean that no more than 25% of the chemical structure of the main blocked developer, on a molecular weight basis, is replaced by different chemical substituents in the additive.

There are limitations to the level of secondary or “additive developer” (not necessarily the second blocked developer) that is useful. Too high of concentration would cause sensitometric effects. To low of a concentration would not help the crystal growth problems.

In the following description, it is to be understood that either the first blocked developer or second blocked developer, as defined below, can be the primary or main blocked developer of interest (i.e., present in an amount greater than 50 weight percent in the mixture of blocked developers) and the other of the first and second developer can be used in an additive amount, less than 50 weight percent, preferably less than 20 weight percent of the developer mixture.

Solid particle dispersions of blocked developers useful in imaging elements, such as photographic (including photothermographic) elements, can be prepared more quickly, or with a finer particle size, and with improved stability to particle growth and needle growth if the blocked developer of interest is mixed with a structurally similar blocked developer prior to dispersal. The amount of additive developer used can vary over a wide range as long as it is less than that of the main blocked developer of interest. Preferably, the additive developer is used in the range of 0.05% to 50%, more preferably at or above at least 0.1% and at or below at most 20%, and most preferably at or above at least 0.5% and at or below at most 10%, the percentages being by weight, based on the weight of the primary blocked developer of interest.

In the case of milling dispersal methods, a coarse aqueous premix containing the solid blocked developer useful in imaging and water, and, optionally, any desired combination of water soluble surfactants and polymers, is made, and the structurally similar additive is added to this premix prior to the milling operation. The resulting mixture is then loaded into a mill. The mill can be, for example, a ball mill, media mill, attritor mill, jet mill, vibratory mill, or the like. The mill is charged with the appropriate milling media such as, for example, beads of silica, silicon nitride, sand, zirconium oxide, yttria-stabilized zirconium oxide, alumina, titanium, glass, polystyrene, etc. The bead sizes typically range from 0.25 to 3.0 mm in diameter, but smaller media may also be used if desired. Blocked developers and structurally similar additives in the slurry are subjected to repeated collisions with the milling media, resulting in crystal fracture and consequent particle size reduction.

Generally, for use in imaging elements, a solid particle dispersion of this invention should have an average particle size of 0.01 to about 10 mm, preferably 0.05 to about 5 μm, and more preferably about 0.05 to about 3 μm. Most preferably, the solid particles are of a sub-micron average size. Generally, the desired particle size can be achieved by milling the slurry for 30 minutes to 31 days, preferably 60 minutes to 14 days, depending on the mill used. The amount of additive used is preferably in the range of 0.05% to 50%, and is more preferably at or above at least 0.1% and at or below at most 20%, the percentages being by weight, based on the weight of the main blocked developer of interest. It is preferred that the structurally similar additive developer be incorporated before milling in accordance with this embodiment of the invention, as we believe the repeated collisions between the main blocked developer and the additive developer in the mill help to achieve the desired particle size stability.

In the case of pH precipitation techniques, an aqueous solution of the main blocked developer of interest is made at relatively high pH. The structurally similar additive is simultaneously dissolved in this high pH solution prior to lowering the pH to cause precipitation. The aqueous solution can further contain appropriate surfactants and polymers previously disclosed for use in making pH precipitated dispersions. For solvent precipitation, a solution of the blocked developer of interest is made in some water miscible, organic solvent, in which the additive is also dissolved. The solution of the main blocked developer and the additive developer is added to an aqueous solution containing appropriate surfactants or polymers to cause precipitation as previously disclosed for use in making solvent precipitated dispersions. The amount of additive developer used for precipitated dispersions is preferably at least about 0.5% and at most about 20% of the weight amount of main blocked developer. It is desirable that the structurally similar additive developer be dissolved along with the main blocked developer of interest prior to precipitation in accordance with this embodiment of the invention, as we believe the main blocked developer of interest and the additive developer precipitating together help to achieve the desired stability.

While not restricting our invention to any proposed mechanism, it is believed undesirable particle growth in solid particle dispersions of crystalline blocked developers occurs by an Oswald ripening mechanism, whereby molecules of the solid particle dispersion of blocked developer diffuse through the aqueous phase from small particles to large particles. Blocked developers with even exceptionally low water-solubility have been found to be subject to such particle growth. While not wishing to be bound to any theory, we believe that additives in accordance with the invention are capable of incorporating themselves into a crystal lattice consisting of the main blocked developer and the structurally similar additive developer, and that such incorporation aids in the stability of the dispersed solid particles to undesired particle growth. If the additive blocked developer has less than about 75% of the chemical structure of the main blocked developer, it may not effectively incorporate itself into the surface layers of the crystal lattice of the main blocked developer.

Structurally similar additive developers are defined as distinct blocked developers derived from the chemical structure of the main or parent blocked developer of interest, such that a section comprising at least 75% (measured on an atomic mass basis) of the main blocked developer's chemical structure is maintained in the additive developer. This can be accomplished, conceptually, by breaking one or more bonds in the chemical structure of the blocked developer of interest, and replacing the substituents on one side of the broken bond by different substituents. This new “fragmented” molecule is then reassembled at the site of the broken bond. The structure section common to both the main blocked developer and additive developer must be at least 75% (measured in partial molecular mass) of the main blocked developer.

Surfactants and other additional conventional addenda may also be used in the dispersing processes described herein in accordance with prior art solid particle dispersing procedures. It is specifically contemplated, e.g., to use the surfactants, polymers, and other addenda as disclosed in U.S. Pat. Nos. 5,468,598; 5,300,394; 5,278,037; 4,006,025; 4,294,916; 4,294,917; 4,940,654; 4,950,586; 4,927,744; 5,279,931; 5,158,863; 5,135,844; 5,091,296; 5,089,380; 5,013,640; 4,990,431; 4,970,139; 5,256,527; 5,015,564; 5,008,179; 4,957,857; and 2,870,012; UK 1,570,362; and GB 1,131,399 referenced above, the disclosures of which are hereby incorporated by reference, in the dispersing process of the invention.

Additional surfactants or other water-soluble polymers can also be added after formation of the solid particle dispersion, before or after subsequent addition of the small particle dispersion to an aqueous coating medium. The resulting dispersion of the blocked developer useful in imaging containing the structurally similar additive of this invention can be added to another aqueous medium, if desired, for coating, e.g., onto a photographic or thermal printing element support. The aqueous medium preferably contains other blocked developers such as stabilizers and dispersants, for example, additional anionic, nonionic, zwitterionic, or cationic surfactants, and water-soluble binders such as gelatin as is well known in the imaging element art. This aqueous coating medium may further contain other dispersions or emulsions of blocked developers useful in imaging, especially photography and thermal printing imaging.

In one embodiment of the invention, the primary blocked developer is a blocked form of CD-2. This developer has two ethyl substitutions on the tertiary amine. It was found that homologous developers in which the tertiary amine was substituted with two alkyl groups larger than ethyl could be added as the secondary developer and resulted in improved resistance to crystal growth. The most significant improvements were obtained by using as the secondary developer blocked developers is which the tertiary amine was substituted with a single ethyl group in a addition to a longer alkyl substituents such as one comprising 4 or 6 carbon atoms.

The primary and additive blocked developer, although differing in structure, both may independently be represented by the following Structure I:
DEV-(LINK 1)ₗ-(TIME)ₘ-(LINK 2)ₙ-B I
wherein,

DEV is a phenylene diamine moiety as defined below that, when released, forms a silver-halide color developing agent:

LINK 1 and LINK 2 are linking groups;

TIME is a timing group;

l is 0 or 1;

m is 0, 1, or 2;

n is 0 or 1;

l+n is 1 or 2; and DEV has the following structure:

B is a blocking group for a first DEV moiety that comprises a second DEV moiety, which blocking group B is represented by the following structure:
-B′-(LINK 2)ₙ-(TIME)ₘ-(LINK 1)ₗ-DEV
wherein B′ can be viewed as a “common blocking group” for both a first and second developing agent DEV.

In a preferred embodiment of the invention, LINK 1 or LINK 2 are independently of Structure II: 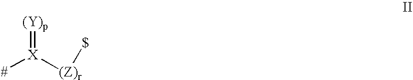
wherein

X represents carbon or sulfur;

Y represents oxygen, sulfur of N—R₁, where R₁ is substituted or unsubstituted alkyl or substituted or unsubstituted aryl;

p is 1 or 2;

Z represents carbon, oxygen or sulfur;

r is 0 or 1;

with the proviso that when X is carbon, both p and r are 1, when X is sulfur, Y is oxygen, p is 2 and r is 0;

# denotes the bond to PUG (for LINK 1) or TIME (for LINK 2):

$ denotes the bond to TIME (for LINK 1) or T₍ₜ₎ substituted carbon (for LINK 2).

Illustrative linking groups include, for example,

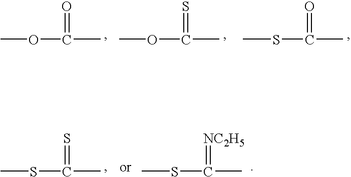

TIME is a timing group. Such groups are well-known in the art such as (1) groups utilizing an aromatic nucleophilic substitution reaction as disclosed in U.S. Pat. No. 5,262,291; (2) groups utilizing the cleavage reaction of a hemiacetal (U.S. Pat. No. 4,146,396, Japanese Applications 60-249148; 60-249149); (3) groups utilizing an electron transfer reaction along a conjugated system (U.S. Pat. Nos. 4,409,323; 4,421,845; Japanese Applications 57-188035; 58-98728; 58-209736; 58-209738); and (4) groups using an intramolecular nucleophilic substitution reaction (U.S. Pat. No. 4,248,962).

Illustrative timing groups are illustrated by formulae T-1 through T-4. 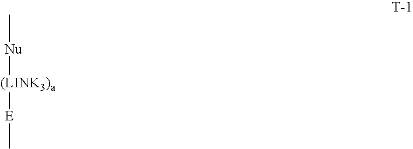
wherein:

Nu is a nucleophilic group;

E is an electrophilic group comprising one or more carbo- or hetero- aromatic rings, containing an electron deficient carbon atom;

LINK 3 is a linking group that provides 1 to 5 atoms in the direct path between the nucleophilic site of Nu and the electron deficient carbon atom in E; and

a is 0 or 1.

Such timing groups include, for example:

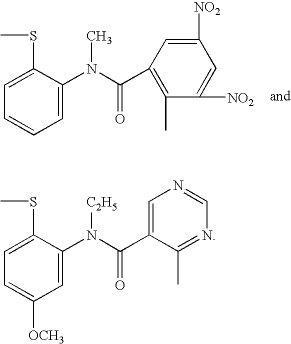

These timing groups are described more fully in U.S. Pat. No. 5,262,291, incorporated herein by reference. 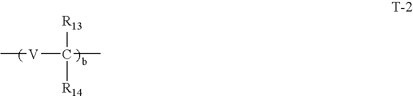
wherein

V represents an oxygen atom, a sulfur atom, or an 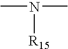
group;

R₁₃ and R₁₄ each represents a hydrogen atom or a substituent group;

R₁₅ represents a substituent group; and b represents 1 or 2.

Typical examples of R₁₃ and R₁₄, when they represent substituent groups, and R₁₅ include 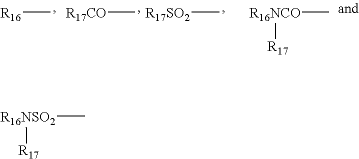
where, R₁₆ represents an aliphatic or aromatic hydrocarbon residue, or a heterocyclic group; and R₁₇ represents a hydrogen atom, an aliphatic or aromatic hydrocarbon residue, or a heterocyclic group, R₁₃, R₁₄ and R₁₅ each may represent a divalent group, and any two of them combine with each other to complete a ring structure. Specific examples of the group represented by formula (T-2) are illustrated below. 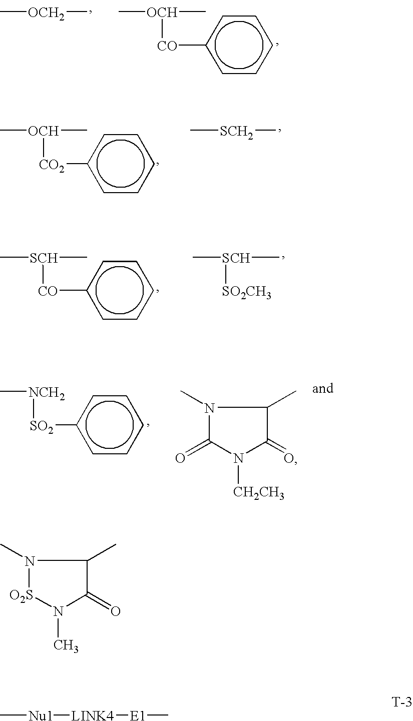
wherein Nu 1 represents a nucleophilic group, and an oxygen or sulfur atom can be given as an example of nucleophilic species; E1 represents an electrophilic group being a group which is subjected to nucleophilic attack by Nu 1; and LINK 4 represents a linking group which enables Nu 1and E1 to have a steric arrangement such that an intramolecular nucleophilic substitution reaction can occur. Specific examples of the group represented by formula (T-3) are illustrated below. 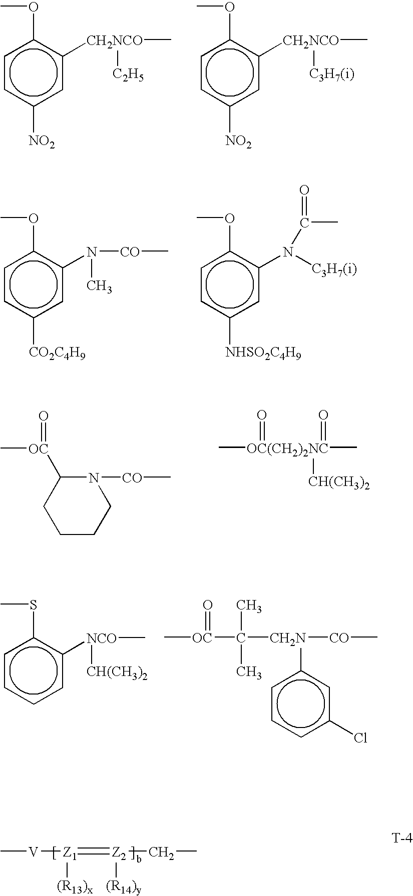
wherein V, R₁₃, R₁₄ and b all have the same meaning as in formula (T-2), respectively. In addition, R₁₃ and R₁₄ may be joined together to form a benzene ring or a heterocyclic ring, or V may be joined with R₁₃ or R₁₄ to form a benzene or heterocyclic ring. Z₁ and Z₂ each independently represents a carbon atom or a nitrogen atom, and x and y each represents 0 or 1.

Specific examples of the timing group (T-4) are illustrated below.

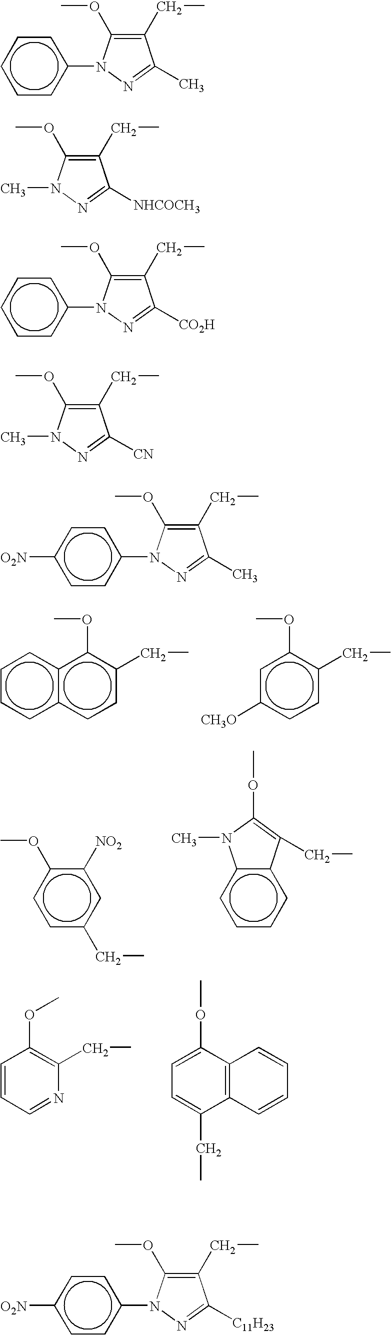

The DEV group in Structure I above is represented, for a second of two blocked developers, by the following Structure III: 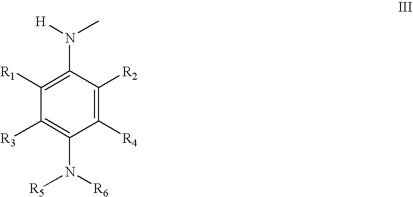
wherein R₁, R₂, R₃, R₄, R₅ and R₆ which can be the same or different are individually H, alkyl, substituted alkyl, alkenyl, substituted alkenyl, aryl, substituted aryl, halogen, cyano, hydroxy, alkoxy, substituted alkoxy, aryloxy, substituted aryloxy, amino, substituted amino, alkylcarbonamido, substituted alkylcarbonamido, arylcarbonamido, substituted arylcarbonamido, alkylsulfonamido, arylsulfonamido, substituted alkylsulfonamido, substituted arylsulfonamido, or sulfamyl or wherein at least two of R₁, R₂, R₃ and R₄, R₅ and R₆ together further form a substituted or unsubstituted carbocyclic or heterocyclic ring structure. In one embodiment, the R₃ and R₅ and the R₄ and R₆ groups form a tetrahydroquinoline (THQ) structure.

Preferably, at least one of R₁ and R₂ is a substituted or unsubstituted alkyl or alkoxy or an alkylsulfonamido, more preferably a C1 to C4 alkyl or alkoxy, most preferably, the alkyl is an n-alkyl substituent. Preferably, R₃ and R₄ are hydrogen. Preferably, R₅ and R₆ are independently hydrogen or a substituted or unsubstituted alkyl group or R₅ and R₆ are connected to form a ring;

In one preferred embodiment, R₅ and R₆ are independently hydrogen or a substituted or unsubstituted alkyl group or R₅ and R₆ are connected to form a ring;

R₁, R₂, R₃, and R₄ are independently hydrogen, halogen, hydroxy, amino, alkoxy, carbonamido, sulfonamido, alkylsulfonamido or substituted or unsubstituted alkyl, or R₃ can connect with R₅ or R₁ and/or R₄ can connect to R₆ or R₂ to form a ring.

When released from the blocking group, the DEV moiety for the second blocked developer forms the following developing agent: 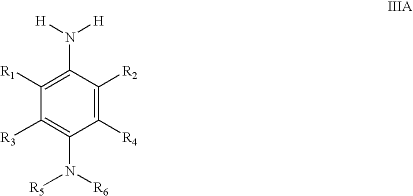
wherein R₁ through R₆ are as defined above.

In one embodiment of the invention, the second blocked developer has the following structure: 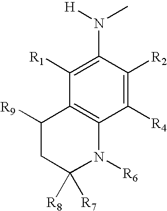
wherein R₆, R₇, R₈, and R₉ can be any of the substituents named for R1.

The first blocked developer is independently represented by Structure III except that R₅ is the same as R₆ and both are alkyl groups. The DEV in the first blocked developer is the same as the DEV in the second blocked developer except either (a) differs with respect to R₅ and/or R₆ and/or (b) differs by the number of carbons in any one or more substituents R₁, R₂, R₃, R₄ on the phenylene ring in Structure III.

In a preferred embodiment, in the second blocked developer:

(a) R₅ is not R₆ and the difference between at least one of R₅ and R₆ in the second blocked developer, respectively, with respect to R₅ and R₆ in the first developer is the addition of at least 1 carbon, or wherein R₅ or R₆ in the second blocked developer forms a fused ring with the phenyldiamine ring in Structure III; with the proviso (i) that if a heteroatom, preferably either N or O, is present in R₅ or R₆ in the second blocked developer, then no hydrogen is attached to the heteroatom; and with the additional proviso (ii) that R₅ and R₆ in the second blocked developer do not form a ring that is symmetrical around an axis connecting both nitrogens in Structure III; and/or

(b) at least one carbon is added to an existing ring substituent R₁, R₂, R₃, or R₄ compared to the R₁, R₂, R₃, R₄ in the first blocked developer, or (ii) at least one substituent having at least one carbon is added to a ring carbon vicinal to the —NR₅R₆ (3 or 5 position ) in the phenyl ring compared to the first blocked developer, and/or (iii) at least one carbon is removed from an existing ring substituent R₁, R₂, R₃, R₄ such that the final ring substituents are asymmetric with respect to the nitrogen-nitrogen axis in Structure III.

More preferably, the first blocked developer, which is preferably the primary or main blocked developer(after being released from the first blocked developer during development) is the neutral or photographically acceptable salt form of the compound represented by the following Structure IV: 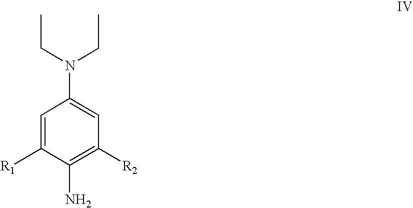
wherein R¹ and R² are as described above.

In one embodiment, both blocked developers fall within the following Structure: 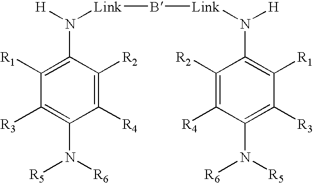
wherein LINK is as defined for LINK1 above and wherein R₁ through R₆ are as defined above. The B′ is a divalent organic moiety and preferably corresponds to the divalent moiety between the two (TIME)ₙ groups in Structure V and Structure VA below.

Preferably, both blocked developers, the primary and the additive developer, meet the following Structure V: 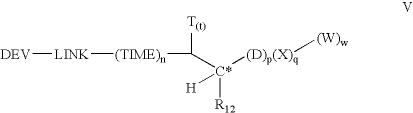
wherein:

DEV is as defined above and forms, upon release, a developing agent;

LINK is a linking group as defined above for LINK1 or LINK2;

TIME is a timing group as defined above;

n is 0, 1, or 2;

t is 0, 1, or 2, and when t is not 2, the necessary number of hydrogens (2-t) are present in the structure;

C* is tetrahedral (sp³ hybridized) carbon;

p is 0 or 1;

q is 0 or 1;

w is 0 or 1;

p+q=1 and when p is 1, q and w are both 0; when q is 1, then w is 1;

R₁₂ is hydrogen, or a substituted or unsubstituted alkyl, cycloalkyl, aryl or heterocyclic group or R₁₂ can combine with W to form a ring;

T is independently selected from a substituted or unsubstituted (referring to the following T groups) alkyl group, cycloalkyl group, aryl, or heterocyclic group, an inorganic monovalent electron withdrawing group, or an inorganic divalent electron withdrawing group capped with at least one C1 to C10 organic group (either an R₁₃ or an R₁₃ and R₁₄ group), preferably capped with a substituted or unsubstituted alkyl or aryl group; or T is joined with W or R₁₂ to form a ring; or two T groups can combine to form a ring;

T is an activating group when T is an (organic or inorganic) electron withdrawing group, an aryl group substituted with one to seven electron withdrawing groups, or a substituted or unsubstituted heteroaromatic group. Preferably, T is an inorganic group such as halogen, —NO₂, —CN; a halogenated alkyl group, for example —CF₃, or an inorganic electron withdrawing group capped by R₁₃ or by R₁₃ and R₁₄, for example, —SO₂R₁₃, —OSO₂R₁₃, —NR₁₄(SO₂R₁₃), —CO₂R₁₃, —COR,₁₃, —NR₁₄(COR₁₃), etc. A particularly preferred T group is an aryl group substituted with one to seven electron withdrawing groups.

D is a first activating group selected from substituted or unsubstituted (referring to the following D groups) heteroaromatic group or aryl group or monovalent electron withdrawing group, wherein the heteroaromatic can optionally form a ring with T or R₁₂;

X is a second activating group and is a divalent electron withdrawing group. The X groups comprise an oxidized carbon, sulfur, or phosphorous atom that is connected to at least one W group. Preferably, the X group does not contain any tetrahedral carbon atoms except for any side groups attached to a nitrogen, oxygen, sulfur or phosphorous atom. The X groups include, for example, —CO—, —SO₂—, —SO₂O—, —COO—, —SO₂N(R₁₅)—, —CON(R₁₅)—, —OPO(OR₁₅)—, —PO(OR₁₅)N(R₁₆)—, and the like, in which the atoms in the backbone of the X group (in a direct line between the C* and W) are not attached to any hydrogen atoms.

W is a group represented by the following Structure VA:

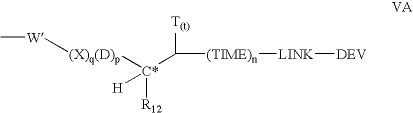

W′ is independently selected from a substituted or unsubstituted (referring to the following W′ groups) alkyl (preferably containing 1 to 6 carbon atoms), cycloalkyl (including bicycloalkyls, but preferably containing 4 to 6 carbon atoms), aryl (such as phenyl or naphthyl) or heterocyclic group; and wherein W′ in combination with T or R₁₂ can form a ring (in the case of Structure IA, W′ comprises a least one substituent, namely the moiety to the right of the W′ group in Structure IA, which substituent is by definition activating, comprising either X or D);

W is an activating group when W has structure IA or when W′ is an alkyl or cycloalkyl group substituted with one or more electron withdrawing groups; an aryl group substituted with one to seven electron withdrawing groups, a substituted or unsubstituted heteroaromatic group; or a non-aromatic heterocyclic when substituted with one or more electron withdrawing groups. More preferably, when W is substituted with an electron withdrawing group, the substituent is an inorganic group such as halogen, —NO₂, or —CN; or a halogenated alkyl group, e.g., —CF₃, or an inorganic group capped by R₁₃ (or by R₁₃ and R₁₄), for example —SO₂R₁₃, —OSO₂R₁₃, —NR₁₃(SO₂R₁₄), —CO₂R₁₃, —COR₁₃, —NR₁₃(COR₁₄), etc.

R₁₃, R₁₄, R₁₅, and R₁₆ can independently be selected from substituted or unsubstituted alkyl, aryl, or heterocyclic group, preferably having 1 to 6 carbon atoms, more preferably a phenyl or C1 to C6 alkyl group.

Any two members (which are not directly linked) of the following set: R₁₂, T, and either D or W, may be joined to form a ring, provided that creation of the ring will not interfere with the functioning of the blocking group.

In one embodiment of the invention, the blocked developer is selected from Structure I with the proviso that when t is 0, then D is not —CN or substituted or unsubstituted aryl and X is not —SO₂— when W is substituted or unsubstituted aryl or alkyl; and when t is not an activating group, then X is not —S₂— when W is a substituted or unsubstituted aryl.

By the term inorganic is herein meant a group not containing carbon excepting carbonates, cyanides, and cyanates. The term heterocyclic herein includes aromatic and non-aromatic rings containing at least one (preferably 1 to 3) heteroatoms in the ring. If the named groups for a symbol such as T in Structure I apparently overlap, the narrower named group is excluded from the broader named group solely to avoid any such apparent overlap. Thus, for example, heteroaromatic groups in the definition of T may be electron withdrawing in nature, but are not included under monovalent or divalent electron withdrawing groups as they are defined herein.

When referring to electron-withdrawing groups, this can be indicated or estimated by the Hammett substituent constants (σₚ, σₘ), as described by L. P. Hammett in Physical Organic Chemistry (McGraw-Hill Book Co., NY, 1940), or by the Taft polar substituent constants (σ_{I}) as defined by R. W. Taft in Steric Effects in Organic Chemistry (Wiley and Sons, NY, 1956), and in other standard organic textbooks. The σₚ and σₘ parameters, which were used first to characterize the ability of benzene ring-substituents (in the para or meta position) to affect the electronic nature of a reaction site, were originally quantified by their effect on the pKa of benzoic acid. Subsequent work has extended and refined the original concept and data, and for the purposes of prediction and correlation, standard sets of σₚ and σₘ are widely available in the chemical literature, as for example in C. Hansch et al., J. Med. Chem., 17, 1207 (1973). For substituents attached to a tetrahedral carbon instead of aryl groups, the inductive substituent constant σ_{I} is herein used to characterize the electronic property. Preferably, an electron withdrawing group on an aryl ring has a σₚ or σₘ of greater than zero, more preferably greater than 0.05, most preferably greater than 0.1. The σₚ is used to define electron withdrawing groups on aryl groups when the substituent is neither para nor meta. Similarly, an electron withdrawing group on a tetrahedral carbon preferably has a σ_{I} of greater than zero, more preferably greater than 0.05, and most preferably greater than 0.1. In the event of a divalent group such as —SO₂—, the σ_{I} used is for the methyl-substituted analogue such as —SO₂CH₃(σ_{I}=0.59). When more than one electron-withdrawing group is present, then the summation of the substituent constants is used to estimate or characterize the total effect of the substituents.

When referring to heteroaromatic groups or substituents, the heteroaromatic group is preferably a 5- or 6-membered ring containing one or more heteroatoms, such as N, O, S or Se. Preferably, the heteroaromatic group comprises a substituted or unsubstituted benzimidazolyl, benzothiazolyl, benzoxazolyl, benzothienyl, benzofuryl, furyl, imidazolyl, indazolyl, indolyl, isoquinolyl, isothiazolyl, isoxazolyl, oxazolyl, picolinyl, purinyl, pyranyl, pyrazinyl, pyrazolyl, pyridyl, pyrimidinyl, pyrrolyl, quinaldinyl, quinazolinyl, quinolyl, quinoxalinyl, tetrazolyl, thiadiazolyl, thiatriazolyl, thiazolyl, thienyl, and triazolyl group. Particularly preferred are: 2-imidazolyl, 2-benzimidazolyl, 2-thiazolyl, 2-benzothiazolyl, 2-oxazolyl, 2-benzoxazolyl, 2-pyridyl, 2-quinolinyl, 1-isoquinolinyl, 2-pyrrolyl, 2-indolyl, 2-thiophenyl, 2-benzothiophenyl, 2-furyl, 2-benzofuryl, 2-,4-, or 5-pyrimidinyl, 2-pyrazinyl, 3-,4-, or 5-pyrazolyl, 3-indazolyl, 2- and 3-thienyl, 2-(1,3,4-triazolyl), 4-or 5-(1,2,3-triazolyl), 5-(1,2,3,4-tetrazolyl) The heterocyclic group may be further substituted. Preferred substituents are alkyl and alkoxy groups containing 1 to 6 carbon atoms.

When reference in this application is made to a particular moiety or group, “substituted or unsubstituted” means that the moiety may be unsubstituted or substituted with one or more substituents (up to the maximum possible number), for example, substituted or unsubstituted alkyl, substituted or unsubstituted benzene (with up to five substituents), substituted or unsubstituted heteroaromatic (with up to five substituents), and substituted or unsubstituted heterocyclic (with up to five substituents). Generally, unless otherwise specifically stated, substituent groups usable on molecules herein include any groups, whether substituted or unsubstituted, which do not destroy properties necessary for the photographic utility. Examples of substituents on any of the mentioned groups can include known substituents, such as: halogen, for example, chloro, fluoro, bromo, iodo; alkoxy, particularly those “lower alkyl” (that is, with 1 to 6 carbon atoms), for example, methoxy, ethoxy; substituted or unsubstituted alkyl, particularly lower alkyl (for example, methyl, trifluoromethyl); thioalkyl (for example, methylthio or ethylthio), particularly either of those with 1 to 6 carbon atoms; substituted and unsubstituted aryl, particularly those having from 6 to 20 carbon atoms (for example, phenyl); and substituted or unsubstituted heteroaryl, particularly those having a 5 or 6-membered ring containing 1 to 3 heteroatoms selected from N, O, or S (for example, pyridyl, thienyl, furyl, pyrrolyl); acid or acid salt groups such as any of those described below; and others known in the art. Alkyl substituents may specifically include “lower alkyl” (that is, having 1-6 carbon atoms), for example, methyl, ethyl, and the like. Cycloalkyl when appropriate includes bicycloalkyl. Further, with regard to any alkyl group or alkylene group, it will be understood that these can be branched, unbranched, or cyclic.

In one preferred embodiment, the blocked developers both fall within the following structure VI: 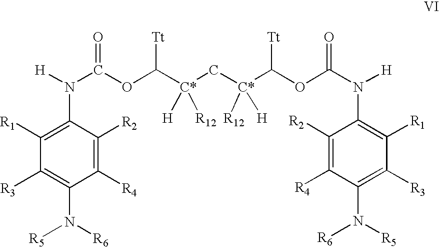
wherein R₁ through R₆, R₁₂ and T₍ₜ₎ are as defined above.

In one embodiment of the invention, a preferred first blocked developer, which is preferably the primary blocked developer, is represented by the following structure:

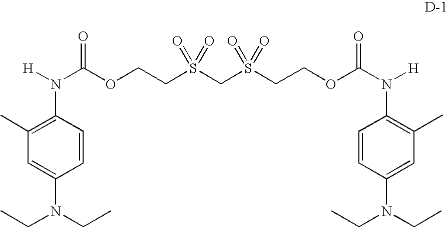

Although the present invention is not limited to any type of developing agent, the following are merely some examples of photographically useful blocked developers that may be used (preferably as the additive developer or growth modifier) in the invention in combination with blocked developer D1:

Useful Growth Modifiers for D-1

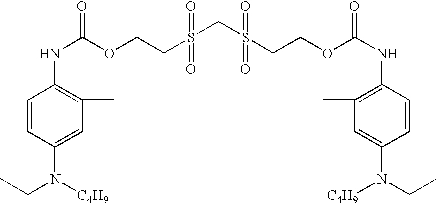

D-2

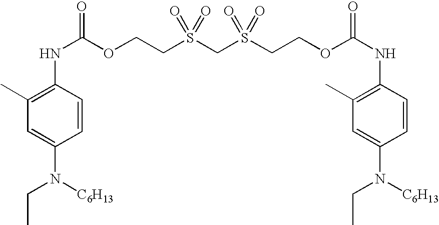

D-3

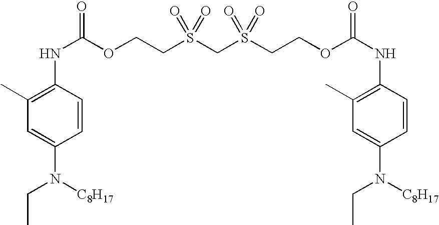

D-4

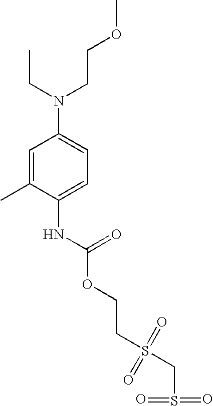

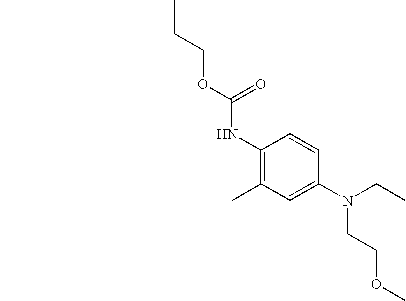

D-5

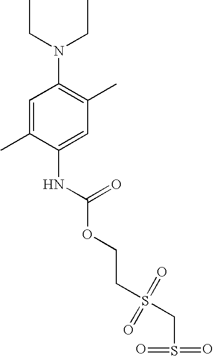

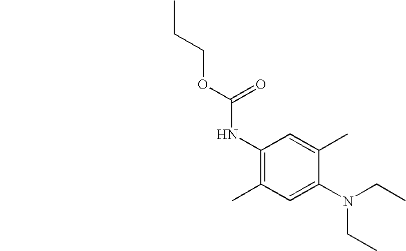

D-6

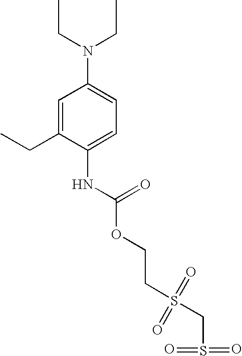

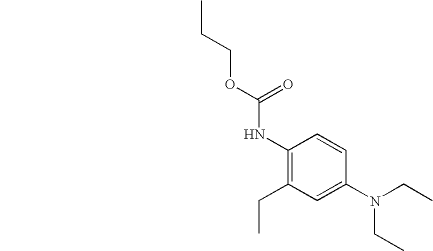

D-7

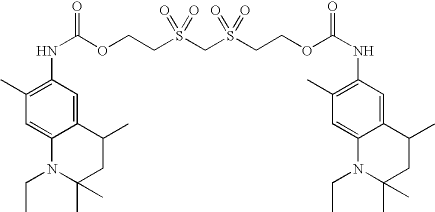

D-8

It is understood that this list is representative only, and not meant to be exclusive. These blocked developers may be synthesized using conventional processes as disclosed in the following referenced patents, or by using analogous techniques, or by modifying the disclosed blocked developers using conventional chemical synthesis techniques: U.S. Pat. Nos. 6,506,546; 6,306,551; U.S. patent application Ser. No. 09/475,703, filed Dec. 30, 1999; and U.S. Pat. Nos. 6,426,179 and 6,312,879. Further improvements in blocked developers are disclosed in U.S. Pat. Nos. 6,413,708; 6,534,226; 6,319,640; and 6,537,712

The blocked developer mixture is preferably incorporated in one or more of the imaging layers of the imaging element. The amount of blocked developer mixture used is preferably 0.01 to 5g/m², more preferably 0.1 to 2g/m² and most preferably 0.3 to 2g/m² in each layer to which it is added. These may be color forming or non-color forming layers of the element. The blocked developer mixture can be contained in a separate element that is contacted to the photographic element during processing.

After image-wise exposure of the imaging element, the blocked developer mixture is activated during processing of the imaging element by the presence of acid or base in the processing solution, by heating the imaging element during processing of the imaging element, and/or by placing the imaging element in contact with a separate element, such as a laminate sheet, during processing. The laminate sheet optionally contains additional processing chemicals such as those disclosed in Sections XIX and XX of Research Disclosure, September 1996, Number 389, Item 38957 (hereafter referred to as (“Research Disclosure I”). All sections referred to herein are sections of Research Disclosure I, unless otherwise indicated. Such chemicals include, for example, sulfites, hydroxyl amine, hydroxamic acids and the like, antifoggants, such as alkali metal halides, nitrogen containing heterocyclic compounds, and the like, sequestering agents such as an organic acids, and other additives such as buffering agents, sulfonated polystyrene, stain reducing agents, biocides, desilvering agents, stabilizers and the like.

The blocked compounds may be used in any form of photographic system. A typical color negative film construction useful in the practice of the invention is illustrated by the following element, SCN-1

Element SCN-1

| | |
|---|---|
| SOC | Surface Overcoat |
| BU | Blue Recording Layer Unit |
| IL1 | First Interlayer |
| GU | Green Recording Layer Unit |
| IL2 | Second Interlayer |
| RU | Red Recording Layer Unit |
| AHU | Antihalation Layer Unit |
| S | Support |
| SOC | Surface Overcoat |

The support S can be either reflective or transparent, which is usually preferred. When reflective, the support is white and can take the form of any conventional support currently employed in color print elements. When the support is transparent, it can be colorless or tinted and can take the form of any conventional support currently employed in color negative elements—e.g., a colorless or tinted transparent film support. Details of support construction are well understood in the art. Examples of useful supports are poly(vinylacetal) film, polystyrene film, poly(ethyleneterephthalate) film, poly(ethylene naphthalate) film, polycarbonate film, and related films and resinous materials, as well as paper, cloth, glass, metal, and other supports that withstand the anticipated processing conditions. The element can contain additional layers, such as filter layers, interlayers, overcoat layers, subbing layers, antihalation layers and the like. Transparent and reflective support constructions, including subbing layers to enhance adhesion, are disclosed in Section XV of Research Disclosure I.

Photographic elements of the present invention may also usefully include a magnetic recording material as described in Research Disclosure, Item 34390, November 1992, or a transparent magnetic recording layer such as a layer containing magnetic particles on the underside of a transparent support as in U.S. Pat. Nos. 4,279,945 and 4,302,523.

Each of blue, green and red recording layer units BU, GU and RU are formed of one or more hydrophilic colloid layers and contain at least one radiation-sensitive silver halide emulsion and coupler, including at least one dye image-forming coupler. It is preferred that the green, and red recording units are subdivided into at least two recording layer sub-units to provide increased recording latitude and reduced image granularity. In the simplest contemplated construction each of the layer units or layer sub-units consists of a single hydrophilic colloid layer containing emulsion and coupler. When coupler present in a layer unit or layer sub-unit is coated in a hydrophilic colloid layer other than an emulsion-containing layer, the coupler containing hydrophilic colloid layer is positioned to receive oxidized color developing agent from the emulsion during development. Usually the coupler-containing layer is the next adjacent hydrophilic colloid layer to the emulsion containing layer.

In order to ensure excellent image sharpness, and to facilitate manufacture and use in cameras, all of the sensitized layers are preferably positioned on a common face of the support. When in spool form, the element will be spooled such that when unspooled in a camera, exposing light strikes all of the sensitized layers before striking the face of the support carrying these layers. Further, to ensure excellent sharpness of images exposed onto the element, the total thickness of the layer units above the support should be controlled. Generally, the total thickness of the sensitized layers, interlayers and protective layers on the exposure face of the support are less than 35 μm.

Any convenient selection from among conventional radiation-sensitive silver halide emulsions can be incorporated within the layer units and used to provide the spectral absorptances of the invention. Most commonly high bromide emulsions containing a minor amount of iodide are employed. To realize higher rates of processing, high chloride emulsions can be employed. Radiation-sensitive silver chloride, silver bromide, silver iodobromide, silver iodochloride, silver chlorobromide, silver bromochloride, silver iodochlorobromide and silver iodobromochloride grains are all contemplated. The grains can be either regular or irregular (e.g., tabular). Tabular grain emulsions, those in which tabular grains account for at least 50 (preferably at least 70 and optimally at least 90) percent of total grain projected area are particularly advantageous for increasing speed in relation to granularity. To be considered tabular a grain requires two major parallel faces with a ratio of its equivalent circular diameter (ECD) to its thickness of at least 2. Specifically preferred tabular grain emulsions are those having a tabular grain average aspect ratio of at least 5 and, optimally, greater than 8. Preferred mean tabular grain thicknesses are less than 0.3 μm (most preferably less than 0.2 μm). Ultrathin tabular grain emulsions, those with mean tabular grain thicknesses of less than 0.07 μm, are specifically contemplated. The grains preferably form surface latent images so that they produce negative images when processed in a surface developer in color negative film forms of the invention.

Illustrations of conventional radiation-sensitive silver halide emulsions are provided by Research Disclosure I, cited above, I. Emulsion grains and their preparation. Chemical sensitization of the emulsions, which can take any conventional form, is illustrated in section IV. Chemical sensitization. Compounds useful as chemical sensitizers, include, for example, active gelatin, sulfur, selenium, tellurium, gold, platinum, palladium, iridium, osmium, rhenium, phosphorous, or combinations thereof. Chemical sensitization is generally carried out at pAg levels of from 5 to 10, pH levels of from 4 to 8, and temperatures of from 30 to 80° C. Spectral sensitization and sensitizing dyes, which can take any conventional form, are illustrated by section V. Spectral sensitization and desensitization. The dye may be added to an emulsion of the silver halide grains and a hydrophilic colloid at any time prior to (e.g., during or after chemical sensitization) or simultaneous with the coating of the emulsion on a photographic element. The dyes may, for example, be added as a solution in water or an alcohol or as a dispersion of solid particles. The emulsion layers also typically include one or more antifoggants or stabilizers, which can take any conventional form, as illustrated by section VII. Antifoggants and stabilizers.

The silver halide grains to be used in the invention may be prepared according to methods known in the art, such as those described in Research Disclosure I, cited above, and James, The Theory of the Photographic Process. These include methods such as ammoniacal emulsion making, neutral or acidic emulsion making, and others known in the art. These methods generally involve mixing a water soluble silver salt with a water soluble halide salt in the presence of a protective colloid, and controlling the temperature, pAg, pH values, etc, at suitable values during formation of the silver halide by precipitation.

In the course of grain precipitation one or more dopants (grain occlusions other than silver and halide) can be introduced to modify grain properties. For example, any of the various conventional dopants disclosed in Research Disclosure I, Section I. Emulsion grains and their preparation, sub-section G. Grain modifying conditions and adjustments, paragraphs (3), (4) and (5), can be present in the emulsions of the invention. In addition it is specifically contemplated to dope the grains with transition metal hexacoordination complexes containing one or more organic ligands, as taught by Olm et al U.S. Pat. 5,360,712, the disclosure of which is here incorporated by reference.

It is specifically contemplated to incorporate in the face centered cubic crystal lattice of the grains a dopant capable of increasing imaging speed by forming a shallow electron trap (hereinafter also referred to as a SET) as discussed in Research Disclosure Item 36736 published November 1994, here incorporated by reference.

The photographic elements of the present invention, as is typical, provide the silver halide in the form of an emulsion. Photographic emulsions generally include a vehicle for coating the emulsion as a layer of a photographic element. Useful vehicles include both naturally occurring substances such as proteins, protein derivatives, cellulose derivatives (e.g., cellulose esters), gelatin (e.g., alkali-treated gelatin such as cattle bone or hide gelatin, or acid treated gelatin such as pigskin gelatin), deionized gelatin, gelatin derivatives (e.g., acetylated gelatin, phthalated gelatin, and the like), and others as described in Research Disclosure, I. Also useful as vehicles or vehicle extenders are hydrophilic water-permeable colloids. These include synthetic polymeric peptizers, carriers, and/or binders such as poly(vinyl alcohol), poly(vinyl lactams), acrylamide polymers, polyvinyl acetals, polymers of alkyl and sulfoalkyl acrylates and methacrylates, hydrolyzed polyvinyl acetates, polyamides, polyvinyl pyridine, methacrylamide copolymers. The vehicle can be present in the emulsion in any amount useful in photographic emulsions. The emulsion can also include any of the addenda known to be useful in photographic emulsions.

While any useful quantity of light sensitive silver, as silver halide, can be employed in the elements useful in this invention, it is preferred that the total quantity be less than 10 g/m² of silver. Silver quantities of less than 7 g/m² are preferred, and silver quantities of less than 5 g/m² are even more preferred. The lower quantities of silver improve the optics of the elements, thus enabling the production of sharper pictures using the elements. These lower quantities of silver are additionally important in that they enable rapid development and desilvering of the elements. Conversely, a silver coating coverage of at least 1.5 g of coated silver per m² of support surface area in the element is necessary to realize an exposure latitude of at least 2.7 log E while maintaining an adequately low graininess position for pictures intended to be enlarged.

BU contains at least one yellow dye image-forming coupler, GU contains at least one magenta dye image-forming coupler, and RU contains at least one cyan dye image-forming coupler. Any convenient combination of conventional dye image-forming couplers can be employed. Conventional dye image-forming couplers are illustrated by Research Disclosure I, cited above, X. Dye image formers and modifiers, B. Image-dye-forming couplers. The photographic elements may further contain other image-modifying compounds such as “Development Inhibitor-Releasing” compounds (DIR's). Useful additional DIR's for elements of the present invention, are known in the art and examples are described in U.S. Pat. Nos. 3,137,578; 3,148,022; 3,148,062; 3,227,554; 3,384,657; 3,379,529; 3,615,506; 3,617,291; 3,620,746; 3,701,783; 3,733,201; 4,049,455; 4,095,984; 4,126,459; 4,149,886; 4,150,228; 4,211,562; 4,248,962; 4,259,437; 4,362,878; 4,409,323; 4,477,563; 4,782,012; 4,962,018; 4,500,634; 4,579,816; 4,607,004; 4,618,571; 4,678,739; 4,746,600; 4,746,601; 4,791,049; 4,857,447; 4,865,959; 4,880,342; 4,886,736; 4,937,179; 4,946,767; 4,948,716; 4,952,485; 4,956,269; 4,959,299; 4,966,835; 4,985,336 as well as in patent publications GB 1,560,240; GB 2,007,662; GB 2,032,914; GB 2,099,167; DE 2,842,063, DE 2,937,127; DE 3,636,824; DE 3,644,416 as well as the following European Pat. Publications: 272,573; 335,319; 336,411; 346,899; 362,870; 365,252; 365,346; 373,382; 376,212; 377,463; 378,236; 384,670; 396,486; 401,612; and 401,613.

DIR compounds are also disclosed in “Developer-Inhibitor-Releasing (DIR) Couplers for Color Photography,” C. R. Barr, J. R. Thirtle and P. W. Vittum in Photographic Science and Engineering, Vol. 13, p. 174 (1969), incorporated herein by reference.

It is common practice to coat one, two or three separate emulsion layers within a single dye image-forming layer unit. When two or more emulsion layers are coated in a single layer unit, they are typically chosen to differ in sensitivity. When a more sensitive emulsion is coated over a less sensitive emulsion, a higher speed is realized than when the two emulsions are blended. When a less sensitive emulsion is coated over a more sensitive emulsion, a higher contrast is realized than when the two emulsions are blended. It is preferred that the most sensitive emulsion be located nearest the source of exposing radiation and the slowest emulsion be located nearest the support.

One or more of the layer units of the invention is preferably subdivided into at least two, and more preferably three or more sub-unit layers. It is preferred that all light sensitive silver halide emulsions in the color recording unit have spectral sensitivity in the same region of the visible spectrum. In this embodiment, while all silver halide emulsions incorporated in the unit have spectral absorptance according to invention, it is expected that there are minor differences in spectral absorptance properties between them. In still more preferred embodiments, the sensitizations of the slower silver halide emulsions are specifically tailored to account for the light shielding effects of the faster silver halide emulsions of the layer unit that reside above them, in order to provide an imagewise uniform spectral response by the photographic recording material as exposure varies with low to high light levels. Thus higher proportions of peak light absorbing spectral sensitizing dyes may be desirable in the slower emulsions of the subdivided layer unit to account for on-peak shielding and broadening of the underlying layer spectral sensitivity.

The interlayers IL1 and IL2 are hydrophilic colloid layers having as their primary function color contamination reduction—i.e., prevention of oxidized developing agent from migrating to an adjacent recording layer unit before reacting with dye-forming coupler. The interlayers are in part effective simply by increasing the diffusion path length that oxidized developing agent must travel. To increase the effectiveness of the interlayers to intercept oxidized developing agent, it is conventional practice to incorporate oxidized developing agent. Antistain agents (oxidized developing agent scavengers) can be selected from among those disclosed by Research Disclosure I, X. Dye image formers and modifiers, D. Hue modifiers/stabilization, paragraph (2). When one or more silver halide emulsions in GU and RU are high bromide emulsions and, hence have significant native sensitivity to blue light, it is preferred to incorporate a yellow filter, such as Carey Lea silver or a yellow processing solution decolorizable dye, in IL1. Suitable yellow filter dyes can be selected from among those illustrated by Research Disclosure I, Section VIII. Absorbing and scattering materials, B. Absorbing materials. In elements of the instant invention, magenta colored filter materials are absent from IL2 and RU.

The antihalation layer unit AHU typically contains a processing solution removable or decolorizable light absorbing material, such as one or a combination of pigments and dyes. Suitable materials can be selected from among those disclosed in Research Disclosure I, Section VIII. Absorbing materials. A common alternative location for AHU is between the support S and the recording layer unit coated nearest the support.

The surface overcoats SOC are hydrophilic colloid layers that are provided for physical protection of the color negative elements during handling and processing. Each SOC also provides a convenient location for incorporation of addenda that are most effective at or near the surface of the color negative element. In some instances the surface overcoat is divided into a surface layer and an interlayer, the latter functioning as spacer between the addenda in the surface layer and the adjacent recording layer unit. In another common variant form, addenda are distributed between the surface layer and the interlayer, with the latter containing addenda that are compatible with the adjacent recording layer unit. Most typically the SOC contains addenda, such as coating aids, plasticizers and lubricants, antistats and matting agents, such as illustrated by Research Disclosure I, Section IX. Coating physical property modifying addenda. The SOC overlying the emulsion layers additionally preferably contains an ultraviolet absorber, such as illustrated by Research Disclosure I, Section VI. UV dyes/optical brighteners/luminescent dyes, paragraph (1).

Instead of the layer unit sequence of element SCN-1, alternative layer units sequences can be employed and are particularly attractive for some emulsion choices. Using high chloride emulsions and/or thin (<0.2 μm mean grain thickness) tabular grain emulsions all possible interchanges of the positions of BU, GU and RU can be undertaken without risk of blue light contamination of the minus blue records, since these emulsions exhibit negligible native sensitivity in the visible spectrum. For the same reason, it is unnecessary to incorporate blue light absorbers in the interlayers.

When the emulsion layers within a dye image-forming layer unit differ in speed, it is conventional practice to limit the incorporation of dye image-forming coupler in the layer of highest speed to less than a stoichiometric amount, based on silver. The function of the highest speed emulsion layer is to create the portion of the characteristic curve just above the minimum density—i.e., in an exposure region that is below the threshold sensitivity of the remaining emulsion layer or layers in the layer unit. In this way, adding the increased granularity of the highest sensitivity speed emulsion layer to the dye image record produced is minimized without sacrificing imaging speed.

In the foregoing discussion the blue, green and red recording layer units are described as containing yellow, magenta and cyan image dye-forming couplers, respectively, as is conventional practice in color negative elements used for printing. The invention can be suitably applied to conventional color negative construction as illustrated. Color reversal film construction would take a similar form, with the exception that colored masking couplers would be completely absent; in typical forms, development inhibitor releasing couplers would also be absent. In preferred embodiments, the color negative elements are intended exclusively for scanning to produce three separate electronic color records. Thus the actual hue of the image dye produced is of no importance. What is essential is merely that the dye image produced in each of the layer units be differentiable from that produced by each of the remaining layer units. To provide this capability of differentiation it is contemplated that each of the layer units contain one or more dye image-forming couplers chosen to produce image dye having an absorption half-peak bandwidth lying in a different spectral region. It is immaterial whether the blue, green or red recording layer unit forms a yellow, magenta or cyan dye having an absorption half peak bandwidth in the blue, green or red region of the spectrum, as is conventional in a color negative element intended for use in printing, or an absorption half-peak bandwidth in any other convenient region of the spectrum, ranging from the near ultraviolet (300-400 nm) through the visible and through the near infrared (700-1200 nm), so long as the absorption half-peak bandwidths of the image dye in the layer units extend over substantially non-coextensive wavelength ranges. The term “substantially non-coextensive wavelength ranges” means that each image dye exhibits an absorption half-peak band width that extends over at least a 25 (preferably 50) nm spectral region that is not occupied by an absorption half-peak band width of another image dye. Ideally the image dyes exhibit absorption half-peak band widths that are mutually exclusive.

When a layer unit contains two or more emulsion layers differing in speed, it is possible to lower image granularity in the image to be viewed, recreated from an electronic record, by forming in each emulsion layer of the layer unit a dye image which exhibits an absorption half-peak band width that lies in a different spectral region than the dye images of the other emulsion layers of layer unit. This technique is particularly well suited to elements in which the layer units are divided into sub-units that differ in speed. This allows multiple electronic records to be created for each layer unit, corresponding to the differing dye images formed by the emulsion layers of the same spectral sensitivity. The digital record formed by scanning the dye image formed by an emulsion layer of the highest speed is used to recreate the portion of the dye image to be viewed lying just above minimum density. At higher exposure levels second and, optionally, third electronic records can be formed by scanning spectrally differentiated dye images formed by the remaining emulsion layer or layers. These digital records contain less noise (lower granularity) and can be used in recreating the image to be viewed over exposure ranges above the threshold exposure level of the slower emulsion layers. This technique for lowering granularity is disclosed in greater detail by Sutton U.S. Pat. No. 5,314,794, the disclosure of which is here incorporated by reference.

Each layer unit of the color negative elements of the invention produces a dye image characteristic curve gamma of less than 1.5, which facilitates obtaining an exposure latitude of at least 2.7 log E. A minimum acceptable exposure latitude of a multicolor photographic element is that which allows accurately recording the most extreme whites (e.g., a bride's wedding gown) and the most extreme blacks (e.g., a bride groom's tuxedo) that are likely to arise in photographic use. An exposure latitude of 2.6 log E can just accommodate the typical bride and groom wedding scene. An exposure latitude of at least 3.0 log E is preferred, since this allows for a comfortable margin of error in exposure level selection by a photographer. Even larger exposure latitudes are specifically preferred, since the ability to obtain accurate image reproduction with larger exposure errors is realized. Whereas in color negative elements intended for printing, the visual attractiveness of the printed scene is often lost when gamma is exceptionally low, when color negative elements are scanned to create digital dye image records, contrast can be increased by adjustment of the electronic signal information. When the elements of the invention are scanned using a reflected beam, the beam travels through the layer units twice. This effectively doubles gamma (ΔD÷Δlog E) by doubling changes in density (ΔD). Thus, gamma's as low as 1.0 or even 0.6 are contemplated and exposure latitudes of up to about 5.0 log E or higher are feasible. Gammas of about 0.55 are preferred. Gammas of between about 0.4 and 0.5 are especially preferred.

Instead of employing dye-forming couplers, any of the conventional incorporated dye image generating compounds employed in multicolor imaging can be alternatively incorporated in the blue, green and red recording layer units. Dye images can be produced by the selective destruction, formation or physical removal of dyes as a function of exposure. For example, silver dye bleach processes are well known and commercially utilized for forming dye images by the selective destruction of incorporated image dyes. The silver dye bleach process is illustrated by Research Disclosure I, Section X. Dye image formers and modifiers, A. Silver dye bleach.

It is also well known that pre-formed image dyes can be incorporated in blue, green and red recording layer units, the dyes being chosen to be initially immobile, but capable of releasing the dye chromophore in a mobile moiety as a function of entering into a redox reaction with oxidized developing agent. These compounds are commonly referred to as redox dye releasers (RDR's). By washing out the released mobile dyes, a retained dye image is created that can be scanned. It is also possible to transfer the released mobile dyes to a receiver, where they are immobilized in a mordant layer. The image-bearing receiver can then be scanned. Initially the receiver is an integral part of the color negative element. When scanning is conducted with the receiver remaining an integral part of the element, the receiver typically contains a transparent support, the dye image bearing mordant layer just beneath the support, and a white reflective layer just beneath the mordant layer. Where the receiver is peeled from the color negative element to facilitate scanning of the dye image, the receiver support can be reflective, as is commonly the choice when the dye image is intended to be viewed, or transparent, which allows transmission scanning of the dye image. RDR's as well as dye image transfer systems in which they are incorporated are described in Research Disclosure, Vol. 151, November 1976, Item 15162.

It is also recognized that the dye image can be provided by compounds that are initially mobile, but are rendered immobile during imagewise development. Image transfer systems utilizing imaging dyes of this type have long been used in previously disclosed dye image transfer systems. These and other image transfer systems compatible with the practice of the invention are disclosed in Research Disclosure, Vol. 176, December 1978, Item 17643, XXIII. Image transfer systems.

A number of modifications of color negative elements have been suggested for accommodating scanning, as illustrated by Research Disclosure I, Section XIV. Scan facilitating features. These systems to the extent compatible with the color negative element constructions described above are contemplated for use in the practice of this invention.

It is also contemplated that the imaging element of this invention may be used with non-conventional sensitization schemes. For example, instead of using imaging layers sensitized to the red, green, and blue regions of the spectrum, the light-sensitive material may have one white-sensitive layer to record scene luminance, and two color-sensitive layers to record scene chrominance. Following development, the resulting image can be scanned and digitally reprocessed to reconstruct the full colors of the original scene as described in U.S. Pat. No. 5,962,205. The imaging element may also comprise a pan-sensitized emulsion with accompanying color-separation exposure. In this embodiment, the developers of the invention would give rise to a colored or neutral image which, in conjunction with the separation exposure, would enable full recovery of the original scene color values. In such an element, the image may be formed by either developed silver density, a combination of one or more conventional couplers, or “black” couplers such as resorcinol couplers. The separation exposure may be made either sequentially through appropriate filters, or simultaneously through a system of spatially discreet filter elements (commonly called a “color filter array”).

The imaging element of the invention may also be a black and white image-forming material comprised, for example, of a pan-sensitized silver halide emulsion and a developer of the invention. In this embodiment, the image may be formed by developed silver density following processing, or by a coupler that generates a dye which can be used to carry the neutral image tone scale.

When conventional yellow, magenta, and cyan image dyes are formed to read out the recorded scene exposures following chemical development of conventional exposed color photographic materials, the response of the red, green, and blue color recording units of the element can be accurately discerned by examining their densities. Densitometry is the measurement of transmitted light by a sample using selected colored filters to separate the imagewise response of the RGB image dye forming units into relatively independent channels. It is common to use Status M filters to gauge the response of color negative film elements intended for optical printing, and Status A filters for color reversal films intended for direct transmission viewing. In integral densitometry, the unwanted side and tail absorptions of the imperfect image dyes leads to a small amount of channel mixing, where part of the total response of, for example, a magenta channel may come from off-peak absorptions of either the yellow or cyan image dyes records, or both, in neutral characteristic curves. Such artifacts may be negligible in the measurement of a film's spectral sensitivity. By appropriate mathematical treatment of the integral density response, these unwanted off-peak density contributions can be completely corrected providing analytical densities, where the response of a given color record is independent of the spectral contributions of the other image dyes. Analytical density determination has been summarized in the SPSE Handbook of Photographic Science and Engineering, W. Thomas, editor, John Wiley and Sons, New York, 1973, Section 15.3, Color Densitometry, pp. 840-848.

Elements having excellent light sensitivity are best employed in the practice of this invention. The elements should have a sensitivity of at least about ISO 50, preferably have a sensitivity of at least about ISO 100, and more preferably have a sensitivity of at least about ISO 200. Elements having a sensitivity of up to ISO 3200 or even higher are specifically contemplated. The speed, or sensitivity, of a color negative photographic element is inversely related to the exposure required to enable the attainment of a specified density above fog after processing. Photographic speed for a color negative element with a gamma of about 0.65 in each color record has been specifically defined by the American National Standards Institute (ANSI) as ANSI Standard Number PH 2.27-1981 (ISO (ASA Speed)) and relates specifically the average of exposure levels required to produce a density of 0.15 above the minimum density in each of the green light sensitive and least sensitive color recording unit of a color film. This definition conforms to the International Standards Organization (ISO) film speed rating. For the purposes of this application, if the color unit gammas differ from 0.65, the ASA or ISO speed is to be calculated by linearly amplifying or deamplifying the gamma vs. log E (exposure) curve to a value of 0.65 before determining the speed in the otherwise defined manner.

The present invention also contemplates the use of photographic elements of the present invention in what are often referred to as single use cameras (or “film with lens” units). These cameras are sold with film preloaded in them and the entire camera is returned to a processor with the exposed film remaining inside the camera. The one-time-use cameras employed in this invention can be any of those known in the art. These cameras can provide specific features as known in the art such as shutter means, film winding means, film advance means, waterproof housings, single or multiple lenses, lens selection means, variable aperture, focus or focal length lenses, means for monitoring lighting conditions, means for adjusting shutter times or lens characteristics based on lighting conditions or user provided instructions, and means for camera recording use conditions directly on the film. These features include, but are not limited to: providing simplified mechanisms for manually or automatically advancing film and resetting shutters as described at Skarman, U.S. Pat. No. 4,226,517; providing apparatus for automatic exposure control as described at Matterson et al., U.S. Pat. No. 4,345,835; moisture-proofing as described at Fujimura et al., U.S. Pat. No. 4,766,451; providing internal and external film casings as described at Ohmura et al., U.S. Pat. No. 4,751,536; providing means for recording use conditions on the film as described at Taniguchi et al., U.S. Pat. No. 4,780,735; providing lens fitted cameras as described at Arai, U.S. Pat. No. 4,804,987; providing film supports with superior anti-curl properties as described at Sasaki et al., U.S. Pat. No. 4,827,298; providing a viewfinder as described at Ohmura et al., U.S. Pat. No. 4,812,863; providing a lens of defined focal length and lens speed as described at Ushiro et al., U.S. Pat. No. 4,812,866; providing multiple film containers as described at Nakayama et al., U.S. Pat. No. 4,831,398 and at Ohmura et al., U.S. Pat. No. 4,833,495; providing films with improved anti-friction characteristics as described at Shiba, U.S. Pat. No. 4,866,469; providing winding mechanisms, rotating spools, or resilient sleeves as described at Mochida, U.S. Pat. No. 4,884,087; providing a film patrone or cartridge removable in an axial direction as described by Takei et al. at U.S. Pat. Nos. 4,890,130 and 5,063,400; providing an electronic flash means as described at Ohmura et al., U.S. Pat. No. 4,896,178; providing an externally operable member for effecting exposure as described at Mochida et al., U.S. Pat. No. 4,954,857; providing film support with modified sprocket holes and means for advancing said film as described at Murakami, U.S. Pat. No. 5,049,908; providing internal mirrors as described at Hara, U.S. Pat. No. 5,084,719; and providing silver halide emulsions suitable for use on tightly wound spools as described at Yagi et al., European Patent Application No. 0,466,417 A.

While the film may be mounted in the one-time-use camera in any manner known in the art, it is especially preferred to mount the film in the one-time-use camera such that it is taken up on exposure by a thrust cartridge. Thrust cartridges are disclosed by Kataoka et al. U.S. Pat. No. 5,226,613; by Zander U.S. Pat. No. 5,200,777; by Dowling et al. U.S. Pat. No. 5,031,852; and by Robertson et al. U.S. Pat. No. 4,834,306. Narrow bodied one-time-use cameras suitable for employing thrust cartridges in this way are described by Tobioka et al. U.S. Pat. No. 5,692,221.

Cameras may contain a built-in processing capability, for example a heating element. Designs for such cameras including their use in an image capture and display system are disclosed in U.S. Pat. No. 6,302,599, incorporated herein by reference. The use of a one-time use camera as disclosed in said application is particularly preferred in the practice of this invention.

Photographic elements of the present invention are preferably imagewise exposed using any of the known techniques, including those described in Research Disclosure I, Section XVI. This typically involves exposure to light in the visible region of the spectrum, and typically such exposure is of a live image through a lens, although exposure can also be exposure to a stored image (such as a computer stored image) by means of light emitting devices (such as light emitting diodes, CRT and the like). The photothermographic elements are also exposed by means of various forms of energy, including ultraviolet and infrared regions of the electromagnetic spectrum as well as electron beam and beta radiation, gamma ray, x-ray, alpha particle, neutron radiation and other forms of corpuscular wave-like radiant energy in either non-coherent (random phase) or coherent (in phase) forms produced by lasers. Exposures are monochromatic, orthochromatic, or panchromatic depending upon the spectral sensitization of the photographic silver halide.

The elements as discussed above may serve as origination material for some or all of the following processes: image scanning to produce an electronic rendition of the capture image, and subsequent digital processing of that rendition to manipulate, store, transmit, output, or display electronically that image.

The blocked developer dispersions of this invention may be used in photographic elements that contain any or all of the features discussed above, but are intended for different forms of processing. These types of systems will be described in detail below.

Type I: Thermal process systems (thermographic and photothermographic), where processing is initiated solely by the application of heat to the imaging element.

Type II: Low volume systems, where film processing is initiated by contact to a processing solution, but where the processing solution volume is comparable to the total volume of the imaging layer to be processed. This type of system may include the addition of non solution processing aids, such as the application of heat or of a laminate layer that is applied at the time of processing.

Type III: Conventional photographic systems, where film elements are processed by contact with conventional photographic processing solutions, and the volume of such solutions is very large in comparison to the volume of the imaging layer.

Types I, II and III will now be discussed. Type I: Thermographic and Photothermographic Systems

In accordance with one aspect of this invention the blocked developer mixture is incorporated in a photothermographic element. Photothermographic elements of the type described in Research Disclosure 17029 are included by reference. The photothermographic elements may be of type A or type B as disclosed in Research Disclosure I. Type A elements contain in reactive association a photosensitive silver halide, a reducing agent or developer, an activator, and a coating vehicle or binder. In these systems development occurs by reduction of silver ions in the photosensitive silver halide to metallic silver. Type B systems can contain all of the elements of a type A system in addition to a salt or complex of an organic compound with silver ion. In these systems, this organic complex is reduced during development to yield silver metal. The organic silver salt will be referred to as the silver donor. References describing such imaging elements include, for example, U.S. Pat. Nos. 3,457,075; 4,459,350; 4,264,725 and 4,741,992.

The photothermographic element comprises a photosensitive component that consists essentially of photographic silver halide. In the type B photothermographic material it is believed that the latent image silver from the silver halide acts as a catalyst for the described image-forming combination upon processing. In these systems, a preferred concentration of photographic silver halide is within the range of 0.01 to 100 moles of photographic silver halide per mole of silver donor in the photothermographic material.

The Type B photothermographic element comprises an oxidation-reduction image forming combination that contains an organic silver salt oxidizing agent. The organic silver salt is a silver salt which is comparatively stable to light, but aids in the formation of a silver image when heated to 80° C. or higher in the presence of an exposed photocatalyst (i.e., the photosensitive silver halide) and a reducing agent.

Suitable organic silver salts include silver salts of organic compounds having a carboxyl group. Preferred examples thereof include a silver salt of an aliphatic carboxylic acid and a silver salt of an aromatic carboxylic acid. Preferred examples of the silver salts of aliphatic carboxylic acids include silver behenate, silver stearate, silver oleate, silver laureate, silver caprate, silver myristate, silver palmitate, silver maleate, silver fumarate, silver tartarate, silver furoate, silver linoleate, silver butyrate and silver camphorate, mixtures thereof, etc. Silver salts which are substitutable with a halogen atom or a hydroxyl group can also be effectively used. Preferred examples of the silver salts of aromatic carboxylic acid and other carboxyl group-containing compounds include silver benzoate, a silver-substituted benzoate such as silver 3,5-dihydroxybenzoate, silver o-methylbenzoate, silver m-methylbenzoate, silver p-methylbenzoate, silver 2,4-dichlorobenzoate, silver acetamidobenzoate, silver p-phenylbenzoate, etc., silver gallate, silver tannate, silver phthalate, silver terephthalate, silver salicylate, silver phenylacetate, silver pyromellilate, a silver salt of 3-carboxymethyl-4-methyl-4-thiazoline-2-thione or the like as described in U.S. Pat. No. 3,785,830, and silver salt of an aliphatic carboxylic acid containing a thioether group as described in U.S. Pat. No. 3,330,663.

Furthermore, a silver salt of a compound containing an imino group can be used. Preferred examples of these compounds include a silver salt of benzotriazole and a derivative thereof as described in Japanese patent publications 30270/69 and 18146/70, for example a silver salt of benzotriazole or methylbenzotriazole, etc., a silver salt of a halogen substituted benzotriazole, such as a silver salt of 5-chlorobenzotriazole, etc., a silver salt of 1,2,4-triazole, a silver salt of 3-amino-5-mercaptobenzyl-1,2,4-triazole, of 1H-tetrazole as described in U.S. Pat. No. 4,220,709, a silver salt of imidazole and an imidazole derivative, and the like.

A second silver salt with a fog inhibiting property may also be used. The second silver organic salt, or thermal fog inhibitor, according to the present invention include silver salts of thiol or thione substituted compounds having a heterocyclic nucleus containing 5 or 6 ring atoms, at least one of which is nitrogen, with other ring atoms including carbon and up to two hetero-atoms selected from among oxygen, sulfur and nitrogen are specifically contemplated. Typical preferred heterocyclic nuclei include triazole, oxazole, thiazole, thiazoline, imidazoline, imidazole, diazole, pyridine and triazine. Preferred examples of these heterocyclic compounds include a silver salt of 2-mercaptobenzimidazole, a silver salt of 2-mercapto-5-aminothiadiazole, a silver salt of 5-carboxylic-1-methyl-2-phenyl-4-thiopyridine, a silver salt of mercaptotriazine, a silver salt of 2-mercaptobenzoxazole.

The second organic silver salt may be a derivative of a thionamide. Specific examples would include but not be limited to the silver salts of 6-chloro-2-mercapto benzothiazole, 2-mercapto-thiazole, naptho(1,2-d)thiazole-2(1H)-thione, 4-methyl-4-thiazoline-2-thione, 2-thiazolidinethione, 4,5-dimethyl-4-thiazoline-2-thione, 4-methyl-5-carboxy-4-thiazoline-2-thione, and 3-(2-carboxyethyl)-4-methyl-4-thiazoline-2-thione.

Preferably, the second organic silver salt is a derivative of a mercapto-triazole. Specific examples would include, but not be limited to, a silver salt of 3-mercapto-4-phenyl-1,2,4 triazole and a silver salt of 3-mercapto-1,2,4-triazole.

Most preferably the second organic salt is a derivative of a mercapto-tetrazole. In one preferred embodiment, a mercapto tetrazole compound useful in the present invention is represented by the following structure VI: 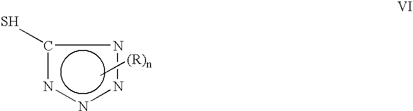
wherein n is 0 or 1, and R is independently selected from the group consisting of substituted or unsubstituted alkyl, aralkyl, or aryl. Substituents include, but are not limited to, C1 to C6 alkyl, nitro, halogen, and the like, which substituents do not adversely affect the thermal fog inhibiting effect of the silver salt. Preferably, n is 1 and R is an alkyl having 1 to 6 carbon atoms or a substituted or unsubstituted phenyl group. Specific examples include but are not limited to silver salts of 1-phenyl-5-mercapto-tetrazole, 1-(3-acetamido)-5-mercapto-tetrazole, or 1-[3-(2-sulfo)benzamidophenyl]-5-mercapto-tetrazole.

The photosensitive silver halide grains and the organic silver salt are coated so that they are in catalytic proximity during development. They can be coated in contiguous layers, but are preferably mixed prior to coating. Conventional mixing techniques are illustrated by Research Disclosure, Item 17029, cited above, as well as U.S. Pat. No. 3,700,458 and published Japanese patent applications Nos. 32928/75, 13224/74, 17216/75 and 42729/76.

A reducing agent in addition to the blocked developer may be included. The reducing agent for the organic silver salt may be any material, preferably organic material, that can reduce silver ion to metallic silver. Conventional photographic developers such as 3-pyrazolidinones, hydroquinones, p-aminophenols, p-phenylenediamines and catechol are useful, but hindered phenol reducing agents are preferred. The reducing agent is preferably present in a concentration ranging from 5 to 25 percent of the photothermographic layer.

A wide range of reducing agents has been disclosed in dry silver systems including amidoximes such as phenylamidoxime, 2-thienylamidoxime and p-phenoxy-phenylamidoxime, azines (e.g., 4-hydroxy-3,5-dimethoxybenzaldehydeazine); a combination of aliphatic carboxylic acid aryl hydrazides and ascorbic acid, such as 2,2′-bis(hydroxymethyl)propionylbetaphenyl hydrazide in combination with ascorbic acid; an combination of polyhydroxybenzene and hydroxylamine, a reductone and/or a hydrazine, e.g., a combination of hydroquinone and bis(ethoxyethyl)hydroxylamine, piperidinohexose reductone or formyl-4-methylphenylhydrazine, hydroxamic acids such as phenylhydroxamic acid, p-hydroxyphenyl-hydroxamic acid, and o-alaninehydroxamic acid; a combination of azines and sulfonamidophenols, e.g., phenothiazine and 2,6-dichloro-4-benzenesulfonamidophenol; cyano-phenylacetic acid derivatives such as ethyl cyano-2-methylphenylacetate, ethyl cyano-phenylacetate; bis-naphthols as illustrated by 2,2′-dihydroxyl- 1 -binaphthyl, 6,6′-dibromo-2,2′-dihydroxy- 1,1′-binaphthyl, and bis(2-hydroxy-1-naphthyl)methane; a combination of bis-o-naphthol and a 1,3-dihydroxybenzene derivative, (e. g., 2,4- dihydroxybenzophenone or 2,4-dihydroxyacetophenone); 5-pyrazolones such as 3-methyl-1-phenyl-5-pyrazolone; reductones as illustrated by dimethylaminohexose reductone, anhydrodihydroaminohexose reductone, and anhydrodihydro-piperidone-hexose reductone; sulfamidophenol reducing agents such as 2,6-dichloro-4-benzene-sulfon-amido-phenol, and p-benzenesulfonamidophenol; 2-phenylindane-1,3-dione and the like; chromans such as 2,2-dimethyl-7-t-butyl-6-hydroxychroman; 1,4-dihydropyridines such as 2,6-dimethoxy-3,5-dicarbethoxy-1,4-dihydropyridene; bisphenols, e.g., bis(2-hydroxy-3-t-butyl-5-methylphenyl)-methane; 2,2-bis(4-hydroxy-3-methyiphenyl)-propane; 4,4-ethylidene-bis(2-t-butyl-6-methylphenol); and 2,2-bis(3,5-dimethyl-4-hydroxyphenyl)propane; ascorbic acid derivatives, e.g., 1-ascorbyl-palmitate, ascorbylstearate and unsaturated aldehydes and ketones, such as benzyl and diacetyl; pyrazolidin-3-ones; and certain indane-1,3-diones.

An optimum concentration of organic reducing agent in the photothermographic element varies depending upon such factors as the particular photothermographic element, desired image, processing conditions, the particular organic silver salt and the particular oxidizing agent.

The photothermographic element can comprise a toning agent, also known as an activator-toner or toner-accelerator. (These may also function as thermal solvents or melt formers.) Combinations of toning agents are also useful in the photothermographic element. Examples of useful toning agents and toning agent combinations are described in, for example, Research Disclosure, June 1978, Item No. 17029 and U.S. Pat. No. 4,123,282. Examples of useful toning agents include, for example, salicylanilide, phthalimide, N-hydroxyphthalimide, N-potassium-phthalimide, succinimide, N-hydroxy-1,8-naphthalimide, phthalazine, 1-(2H)-phthalazinone, 2-acetylphthalazinone, benzanilide, and benzenesulfonamide. Prior-art thermal solvents are disclosed, for example, in U.S. Pat. No. 6,013,420 to Windender. Post-processing image stabilizers and latent image keeping stabilizers are useful in the photothermographic element. Any of the stabilizers known in the photothermographic art are useful for the described photothermographic element. Illustrative examples of useful stabilizers include photolytically active stabilizers and stabilizer precursors as described in, for example, U.S. Pat. No. 4,459,350. Other examples of useful stabilizers include azole thioethers and blocked azolinethione stabilizer precursors and carbamoyl stabilizer precursors, such as described in U.S. Pat. No. 3,877,940.

The photothermographic elements preferably contain various colloids and polymers alone or in combination as vehicles and binders and in various layers. Useful materials are hydrophilic or hydrophobic. They are transparent or translucent and include both naturally occurring substances, such as gelatin, gelatin derivatives, cellulose derivatives, polysaccharides, such as dextran, gum arabic and the like; and synthetic polymeric substances, such as water-soluble polyvinyl compounds like poly(vinylpyrrolidone) and acrylamide polymers. Other synthetic polymeric compounds that are useful include dispersed vinyl compounds such as in latex form and particularly those that increase dimensional stability of photographic elements. Effective polymers include water insoluble polymers of acrylates, such as alkylacrylates and methacrylates, acrylic acid, sulfoacrylates, and those that have cross-linking sites. Preferred high molecular weight materials and resins include poly(vinyl butyral), cellulose acetate butyrate, poly(methylmethacrylate), poly(vinylpyrrolidone), ethyl cellulose, polystyrene, poly(vinylchloride), chlorinated rubbers, polyisobutylene, butadiene-styrene copolymers, copolymers of vinyl chloride and vinyl acetate, copolymers of vinylidene chloride and vinyl acetate, poly(vinyl alcohol) and polycarbonates. When coatings are made using organic solvents, organic soluble resins may be coated by direct mixture into the coating formulations. When coating from aqueous solution, any useful organic soluble materials may be incorporated as a latex or other fine particle dispersion.

Photothermographic elements as described can contain addenda that are known to aid in formation of a useful image. The photothermographic element can contain development modifiers that function as speed increasing compounds, sensitizing dyes, hardeners, antistatic agents, plasticizers and lubricants, coating aids, brighteners, absorbing and filter dyes, such as described in Research Disclosure, December 1978, Item No. 17643 and Research Disclosure, June 1978, Item No. 17029.

The layers of the photothermographic element are coated on a support by coating procedures known in the photographic art, including dip coating, air knife coating, curtain coating or extrusion coating using hoppers. If desired, two or more layers are coated simultaneously.

A photothermographic element as described preferably comprises a thermal stabilizer to help stabilize the photothermographic element prior to exposure and processing. Such a thermal stabilizer provides improved stability of the photothermographic element during storage. Preferred thermal stabilizers are 2-bromo-2-arylsulfonylacetamides, such as 2-bromo-2-p-tolysulfonylacetamide; 2-(tribromomethyl sulfonyl)benzothiazole; and 6-substituted-2,4-bis(tribromomethyl)-s-triazines, such as 6-methyl or 6-phenyl-2,4-bis(tribromomethyl)-s-triazine.

Imagewise exposure is preferably for a time and intensity sufficient to produce a developable latent image in the photothermographic element.

After imagewise exposure of the photothermographic element, the resulting latent image can be developed in a variety of ways. The simplest is by overall heating the element to thermal processing temperature. This overall heating merely involves heating the photothermographic element to a temperature within the range of about 90° C. to about 180° C. until a developed image is formed, such as within about 0.5 to about 60 seconds. By increasing or decreasing the thermal processing temperature a shorter or longer time of processing is useful. A preferred thermal processing temperature is within the range of about 100° C. to about 160° C. Heating means known in the photothermographic arts are useful for providing the desired processing temperature for the exposed photothermographic element. The heating means is, for example, a simple hot plate, iron, roller, heated drum, microwave heating means, heated air, vapor or the like.

It is contemplated that the design of the processor for the photothermographic element be linked to the design of the cassette or cartridge used for storage and use of the element. Further, data stored on the film or cartridge may be used to modify processing conditions or scanning of the element. Methods for accomplishing these steps in the imaging system are disclosed in commonly assigned U.S. Pat. Nos. 6,062,746 and 6,048,110 which are incorporated herein by reference. The use of an apparatus whereby the processor can be used to write information onto the element, information which can be used to adjust processing, scanning, and image display is also envisaged. This system is disclosed in U.S. Pat. No. 6,278,510, which is incorporated herein by reference.

Thermal processing is preferably carried out under ambient conditions of pressure and humidity. Conditions outside of normal atmospheric pressure and humidity are useful.

The components of the photothermographic element can be in any location in the element that provides the desired image. If desired, one or more of the components can be in one or more layers of the element. For example, in some cases, it is desirable to include certain percentages of the reducing agent, toner, stabilizer and/or other addenda in the overcoat layer over the photothermographic image recording layer of the element. This, in some cases, reduces migration of certain addenda in the layers of the element.

In accordance with one aspect of this invention the blocked developer mixture is incorporated in a thermographic element. In thermographic elements an image is formed by imagewise heating the element. Such elements are described in, for example, Research Disclosure, June 1978, Item No. 17029 and U.S. Pat. Nos. 3,080,254; 3,457,075; and 3,933,508, the disclosures or which are incorporated herein by reference. The thermal energy source and means for imaging can be any imagewise thermal exposure source and means that are known in the thermographic imaging art. The thermographic imaging means can be, for example, an infrared heating means, laser, microwave heating means or the like.

Type II: Low Volume Processing:

In accordance with another aspect of this invention the blocked developer mixture is incorporated in a photographic element intended for low volume processing. Low volume processing is defined as processing where the volume of applied developer solution is between about 0.1 to about 10 times, preferably about 0.5 to about 10 times, the volume of solution required to swell the photographic element. This processing may take place by a combination of solution application, external layer lamination, and heating. The low volume processing system may contain any of the elements described above for Type I: Photothermographic systems. In addition, it is specifically contemplated that any components described in the preceding sections that are not necessary for the formation or stability of latent image in the origination film element can be removed from the film element altogether and contacted at any time after exposure for the purpose of carrying out photographic processing, using the methods described below.

The Type II photographic element may receive some or all of the following treatments:
(I) Application of a solution directly to the film by any means, including spray, inkjet, coating, gravure process and the like.
(II) Soaking of the film in a reservoir containing a processing solution. This process may also take the form of dipping or passing an element through a small cartridge.
(III) Lamination of an auxiliary processing element to the imaging element. The laminate may have the purpose of providing processing chemistry, removing spent chemistry, or transferring image information from the latent image recording film element. The transferred image may result from a dye, dye precursor, or silver containing compound being transferred in a image-wise manner to the auxiliary processing element.
(IV) Heating of the element by any convenient means, including a simple hot plate, iron, roller, heated drum, microwave heating means, heated air, vapor, or the like. Heating may be accomplished before, during, after, or throughout any of the preceding treatments I-III. Heating may cause processing temperatures ranging from room temperature to 100° C.
   Type III: Conventional Systems:

In accordance with another aspect of this invention the blocked developer mixture is incorporated in a conventional photographic element.

Conventional photographic elements in accordance with the invention can be processed in any of a number of well-known photographic processes utilizing any of a number of well-known conventional photographic processing solutions, described, for example, in Research Disclosure I, or in T. H. James, editor, The Theory of the Photographic Process, 4th Edition, Macmillan, New York 1977. The development process may take place for any length of time and any process temperature that is suitable to render an acceptable image. In these cases the presence of blocked developers of the invention may be used to provide development in one or more color records of the element, supplementary to the development provided by the developer in the processing solution to give improved signal in a shorter time of development or with lowered laydowns of imaging materials, or to give balanced development in all color records. In the case of processing a negative working element, the element is treated with a color developer (that is one which will form the colored image dyes with the color couplers), and then with a oxidizer and a solvent to remove silver and silver halide. In the case of processing a reversal color element, the element is first treated with a black and white developer (that is, a developer which does not form colored dyes with the coupler compounds) followed by a treatment to fog silver halide (usually chemical fogging or light fogging), followed by treatment with a color developer. Preferred color developing agents are p-phenylenediamines.

Especially preferred are:

4-amino N,N-diethylaniline hydrochloride,

4-amino-3-methyl-N,N-diethylaniline hydrochloride,

4-amino-3-methyl-N-ethyl-N-(2-(methanesulfonamido) ethylaniline sesquisulfate hydrate,

4-amino-3-methyl-N-ethyl-N-(2-hydroxyethyl)aniline sulfate,

4-amino-3-(methanesulfonamido)ethyl-N,N-diethylaniline hydrochloride and

4-amino-N-ethyl-N-(2-methoxyethyl)-m-toluidine di-p-toluene sulfonic acid.

Dye images can be formed or amplified by processes which employ in combination with a dye-image-generating reducing agent an inert transition metal-ion complex oxidizing agent, as illustrated by Bissonette U.S. Pat. Nos. 3,748,138; 3,826,652; 3,862,842; and 3,989,526 and Travis U.S. Pat. No. 3,765,891, and/or a peroxide oxidizing agent as illustrated by Matejec U.S. Pat. No. 3,674,490, Research Disclosure, Vol. 116, December, 1973, Item 11660, and Bissonette Research Disclosure, Vol. 148, August, 1976, Items 14836, 14846 and 14847. The photographic elements can be particularly adapted to form dye images by such processes as illustrated by Dunn et al. U.S. Pat. No. 3,822,129, Bissonette U.S. Pat. Nos. 3,834,907 and 3,902,905, Bissonette et al. U.S. Pat. No. 3,847,619, Mowrey U.S. Pat. No. 3,904,413, Hirai et al. U.S. Pat. No. 4,880,725, Iwano U.S. Pat. No. 4,954,425, Marsden et al. U.S. Pat. No. 4,983,504, Evans et al. U.S. Pat. No. 5,246,822, Twist U.S. Pat. No. 5,324,624, Fyson EPO 0 487 616, Tannahill et al. WO 90/13059, Marsden et al. WO 90/13061, Grimsey et al. WO 91/16666, Fyson WO 91/17479, Marsden et al. WO 92/01972. Tannahill WO 92/05471, Henson WO 92/07299, Twist WO 93/01524 and WO 93/11460 and Wingender et al. German OLS 4,211,460.

Development may be followed by bleach-fixing, to remove silver or silver halide, washing and drying.

Once yellow, magenta, and cyan dye image records have been formed in the processed photographic elements of the invention, conventional techniques can be employed for retrieving the image information for each color record and manipulating the record for subsequent creation of a color balanced viewable image. For example, it is possible to scan the photographic element successively within the blue, green, and red regions of the spectrum or to incorporate blue, green, and red light within a single scanning beam that is divided and passed through blue, green, and red filters to form separate scanning beams for each color record. A simple technique is to scan the photographic element point-by-point along a series of laterally offset parallel scan paths. The intensity of light passing through the element at a scanning point is noted by a sensor which converts radiation received into an electrical signal. Most generally this electronic signal is further manipulated to form a useful electronic record of the image. For example, the electrical signal can be passed through an analog-to-digital converter and sent to a digital computer together with location information required for pixel (point) location within the image. In another embodiment, this electronic signal is encoded with colorimetric or tonal information to form an electronic record that is suitable to allow reconstruction of the image into viewable forms such as computer monitor displayed images, television images, printed images, and so forth.

It is contemplated that many of imaging elements of this invention will be scanned prior to the removal of silver halide from the element. The remaining silver halide yields a turbid coating, and it is found that improved scanned image quality for such a system can be obtained by the use of scanners that employ diffuse illumination optics. Any technique known in the art for producing diffuse illumination can be used. Preferred systems include reflective systems, that employ a diffusing cavity whose interior walls are specifically designed to produce a high degree of diffuse reflection, and transmissive systems, where diffusion of a beam of specular light is accomplished by the use of an optical element placed in the beam that serves to scatter light. Such elements can be either glass or plastic that either incorporate a component that produces the desired scattering, or have been given a surface treatment to promote the desired scattering.

One of the challenges encountered in producing images from information extracted by scanning is that the number of pixels of information available for viewing is only a fraction of that available from a comparable classical photographic print. It is, therefore, even more important in scan imaging to maximize the quality of the image information available. Enhancing image sharpness and minimizing the impact of aberrant pixel signals (i.e., noise) are common approaches to enhancing image quality. A conventional technique for minimizing the impact of aberrant pixel signals is to adjust each pixel density reading to a weighted average value by factoring in readings from adjacent pixels, closer adjacent pixels being weighted more heavily.

The elements of the invention can have density calibration patches derived from one or more patch areas on a portion of unexposed photographic recording material that was subjected to reference exposures, as described by Wheeler et al. U.S. Pat. No. 5,649,260, Koeng at al. U.S. Pat. No. 5,563,717, and by Cosgrove et al. U.S. Pat. No. 5,644,647.

Illustrative systems of scan signal manipulation, including techniques for maximizing the quality of image records, are disclosed by Bayer U.S. Pat. No. 4,553,156; Urabe et al. U.S. Pat. No. 4,591,923; Sasaki et al. U.S. Pat. No. 4,631,578; Alkofer U.S. Pat. No. 4,654,722; Yamada et al. U.S. Pat. No. 4,670,793; Klees U.S. Pat. Nos. 4,694,342 and 4,962,542; Powell U.S. Pat. No. 4,805,031; Mayne et al. U.S. Pat. No. 4,829,370; Abdulwahab U.S. Pat. No. 4,839,721; Matsunawa et al. U.S. Pat. Nos. 4,841,361 and 4,937,662; Mizukoshi et al. U.S. Pat. No. 4,891,713; Petilli U.S. Pat. No. 4,912,569; Sullivan et al. U.S. Pat. Nos. 4,920,501 and 5,070,413; Kimoto et al. U.S. Pat. No. 4,929,979; Hirosawa et al. U.S. Pat. No. 4,972,256; Kaplan U.S. Pat. No. 4,977,521; Sakai U.S. Pat. No. 4,979,027; Ng U.S. Pat. No. 5,003,494; Katayama et al. U.S. Pat. No. 5,008,950; Kimura et al. U.S. Pat. No. 5,065,255; Osamu et al. U.S. Pat. No. 5,051,842; Lee et al. U.S. Pat. No. 5,012,333; Bowers et al. U.S. Pat. No. 5,107,346; Telle U.S. Pat. No. 5,105,266; MacDonald et al. U.S. Pat. No. 5,105,469; and Kwon et al. U.S. Pat. No. 5,081,692. Techniques for color balance adjustments during scanning are disclosed by Moore et al. U.S. Pat. No. 5,049,984 and Davis U.S. Pat. No. 5,541,645.

The digital color records once acquired are in most instances adjusted to produce a pleasingly color balanced image for viewing and to preserve the color fidelity of the image bearing signals through various transformations or renderings for outputting, either on a video monitor or when printed as a conventional color print. Preferred techniques for transforming image bearing signals after scanning are disclosed by Giorgianni et al. U.S. Pat. No. 5,267,030, the disclosures of which are herein incorporated by reference. Further illustrations of the capability of those skilled in the art to manage color digital image information are provided by Giorgianni and Madden Digital Color Management, Addison-Wesley, 1998.

Photographic imaging elements in accordance with one embodiment of the invention may be prepared by coating a support film with one or more photosensitive layers comprising a silver halide emulsion and optionally one or more subbing, inter, overcoat or backcoat layers, at least one of such layers containing a solid particle dispersion of a main blocked developer and an additive prepared in accordance with the invention. The coating processes can be carried out on a continuously operating machine wherein a single layer or a plurality of layers are applied to the support using conventional techniques. For multicolor elements, layers can be coated simultaneously on the composite support film as described in U.S. Pat. Nos. 2,761,791 and 3,508,947. Additional useful coating and drying procedures are described in Research Disclosure, Vol. 176, December 1978, Item 17643. Suitable photosensitive image forming layers are those that provide color or black and white images.

The photosensitive layers can be image-forming layers containing photographic silver halides such as silver chloride, silver bromide, silver bromoiodide, silver chlorobromide, and the like. Both negative working and reversal silver halide elements are contemplated. Suitable emulsions and film formats, as well as examples of other compounds and manufacturing procedures useful in forming photographic imaging elements in accordance with the invention, can be found in Research Disclosure, September 1994, Item 36544, published by Kenneth Mason Publication, Ltd., Dudley House, 12 North Street, Emsworth, Hampshire P010 7DQ, England, and the patents and other references cited therein, the disclosures of which are incorporated herein by reference. The preparation of single and multilayer photographic elements is also described in Research Disclosure 308119, dated December 1989, the disclosure of which is incorporated herein by reference. It is specifically contemplated that the film formats, materials and processes described in an article titled “Typical and Preferred Color Paper, Color Negative, and Color Reversal Photographic Elements and Processing,” published in Research Disclosure, February 1995, Volume 370, the disclosure of which is incorporated herein by reference, may also be advantageously used with the solid particle dispersions of the invention.

The imaging elements of this invention can be coated with a magnetic recording layer as discussed in Research Disclosure 34390 of November 1992, the disclosure of which is incorporated herein by reference.

In accordance with the invention, the solid particle filter dyes can be essentially completely removed or decolorized from a photographic element upon photographic processing with an alkaline aqueous processing solution. The described elements can be, e.g., processed in conventional commercial photographic processes, such as the known C-41 color negative and RA-4 color print processes as described in The British Journal of Photography Annual of 1988, pages 191-199. Motion picture films may be processed with ECN or ECP processes as described in Kodak Publication No. H-24, Manual For Processing Eastman Color Films. Where applicable, the element may be processed in accordance with the Kodak Ektaprint 2 Process as described in Kodak Publication No. Z-122, Using Kodak Ektaprint Chemicals. To provide a positive (or reversal) image, the color development step can be preceded by development with a non-chromogenic developing agent to develop exposed silver halide, but not form dye, and followed by uniformly fogging the element to render unexposed silver halide developable. For elements that lack incorporated dye image formers, sequential reversal color development with developers containing dye image formers such as color couplers is illustrated by the Kodachrome® K-14 process (see U.S. Pat. Nos. 2,252,718; 2,950,970; and 3,547,650). For elements that contain incorporated color couplers, the E-6 color reversal process is described in the British Journal of Photography Annual of 1977, pages 194-197.

The following examples illustrate the preparation and use of stabilized solid particle dispersions in accordance with this invention.

### EXAMPLES

Preparation of D-1 Developer Dispersions for Reduced Needle Growth. D-1 was milled with various additives to observe the effect on needle formation. In addition to the growth modifiers described above, the following comparison compounds were tested:

Comparison Compounds Not Useful
Growth Modifiers with D-1

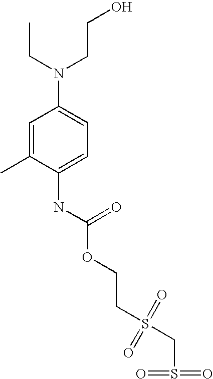

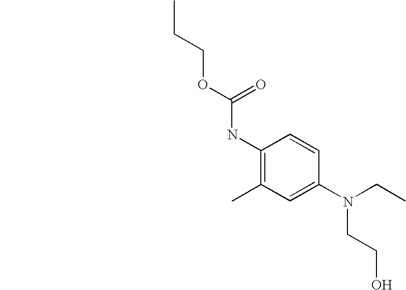

C-1

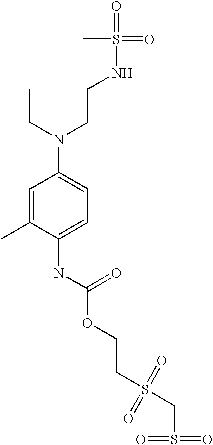

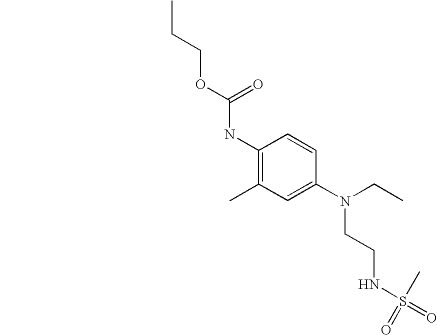

C-2

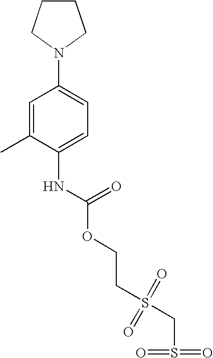

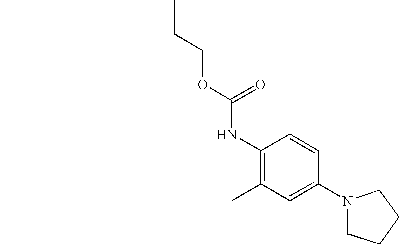

C-3

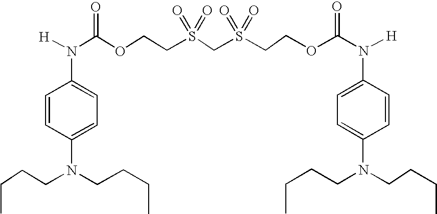

C-4

The following milling procedure was used. The check dispersion was prepared by combining 3 g of D-1 with 3 g of a 10% Olin 10G aqueous solution, 9 g of high purity water and 15 ml of 0.78 mm zirconium silicate beads. The mixture was milled for 90 minutes in a high-energy media mill. After milling, the dispersion was separated from the beads and diluted to 15% developer with high purity water. The dispersion was examined by optical microscopy immediately after milling, and after being held for 24 hours at 45° C.

The test dispersions with the additives were milled and examined 10 in exactly the same way as the check dispersion, except each formula contained 3 g of D-1, 0.3 g of an additive, 3.3 g of a 10% Olin 10G aqueous solution and 8.4 g high purity water.

Results are shown in the following Table with respect to whether the test dispersions gave significantly reduced needle growth compared to the Check.

| | | | Effective as |
|---|---|---|---|
| | | | growth |
| Compound | | Substituent | moderator? |
| D-1 | Control | Ethyl: | No |
| D-2 | Invention | Butyl | Yes |
| D-3 | Invention | Hexyl: | Yes |
| D-4 | Invention | Octyl: | Yes |
| -C-1 | Comparison | 2-hydroxyethyl | No |
| C-2 | Comparison | 2-NHSO2Me | No |
| D-5 | Invention | 2-Methoxyethyl | Yes |
| D-6 | Invention | o-methyl | Yes |
| C-3 | Comparison | Pyrrole | No |
| D-7 | Invention | o-ethyl | Yes |
| C-4 | Comparison | des-methyl, N-butyl | No |
| D-8 | Invention | | Yes |

Results from this Table 1 show that stable solid particle dispersions of a blocked developer can be obtained using a certain class of structurally similar additives, but dispersions prepared with the comparative additives were unstable to particle growth.

The invention has been described in detail with particular reference to preferred embodiments thereof, but it is to be understood that variations and modifications can be effected within the spirit and scope of the invention.

1. A process for preparing a solid particle aqueous dispersion of a first blocked developer useful in imaging elements comprising: (a) adding a structurally similar distinct additive in the form of a second blocked developer, to the first blocked developer, and (b) dispersing the first blocked developer and second blocked developer together in an aqueous medium; wherein both the first blocked developer and the second blocked developer independently have the following Structure I:
DEV-(LINK 1)ₗ-(TIME)ₘ-(LINK 2)ₙ-B I
wherein,
DEV is a phenylene diamine moiety as defined below which when released forms a color developing agent:
LINK 1 and LINK 2 are linking groups;
TIME is a timing group;
l is 0 or 1;
m is 0, 1, or 2;
n is 0 or 1;
l+n is 1 or 2;
B comprises a second phenylene diamine moiety DEV and is represented by the following structure:
-B′-(LINK 2)ₙ-(TIME)ₘ-(LINK 1)ₗ-DEV
wherein B′ is a common blocking group for both DEV moieties;
wherein LINK 1 or LINK 2 are independently of Structure II: 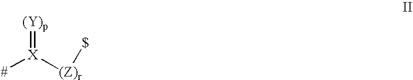
wherein
X represents carbon or sulfur;
Y represents oxygen, sulfur of N—R₁, where R₁ is substituted or unsubstituted alkyl or substituted or unsubstituted aryl;
p is 1 or 2;
Z represents carbon, oxygen or sulfur;
r is 0 or 1;
with the proviso that when X is carbon, both p and r are 1, when X is sulfur, Y is oxygen, p is 2 and r is 0;
# denotes the bond to PUG (for LINK 1) or TIME (for LINK 2):
$ denotes the bond to TIME (for LINK 1) or T₍ₜ₎ substituted carbon (for LINK 2); and
wherein DEV in the second blocked developer is independently represented by the following structure: 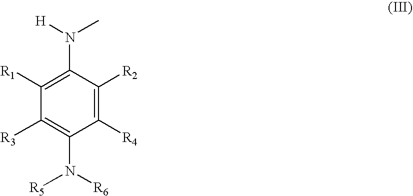
wherein R₁, R₂, R₃, R₄, R₅ and R₆ which can be the same or different are individually H, alkyl, substituted alkyl, alkenyl, substituted alkenyl, aryl, substituted aryl, halogen, cyano, hydroxy, alkoxy, substituted alkoxy, aryloxy, substituted aryloxy, amino, substituted amino, alkylcarbonamido, substituted alkylcarbonamido, arylcarbonamido, substituted arylcarbonamido, alkylsulfonamido, arylsulfonamido, substituted alkylsulfonamido, substituted arylsulfonamido, or sulfamyl or wherein at least two of R₁, R₂, R₃, R₄, R₅ and R₆ together further form a substituted or unsubstituted carbocyclic or heterocyclic ring structure or wherein R₅ or R₆ can optionally form a fused ring with R₃ or R₄, respectively on the phenylene ring; and
wherein the first blocked developer independently is represented by Structure III except that R₅ is the same as R₆ and both are alkyl groups and wherein the DEV in the first blocked developer is the same as the DEV in the second blocked developer except either (a) differs with respect to R₅ and/or R₆ and/or (b) differs by the number of carbons in any one or more substituents R₁, R₂, R₃, R₄ on the phenylene ring in Structure III.

2. The process of claim 1 wherein in the second blocked developer:
(a) R₅ is not R₆ and the difference between at least one of R₅ and R₆ in the second blocked developer, respectively, with respect to R₅ and R₆ in the first developer is the addition of at least 1 carbon, or wherein R₅ or R₆ in the second blocked developer forms a fused ring with the phenyldiamine ring in Structure III; with the proviso (i) that if a heteroatom is present in R₅ or R₆ in the second blocked developer, then no hydrogen is attached to the heteroatom; and with the additional proviso (ii) that R₅ and R₆ in the second blocked developer do not form a ring that is symmetrical around an axis connecting both nitrogens in Structure III; and/or
(b) at least one carbon is added to an existing ring substituent R₁, R₂, R₃, or R₄ compared to the R₁, R₂, R₃, R₄ in the first blocked developer, or (ii) at least one substituent having at least one carbon is added to a ring carbon vicinal to the —NR₅R₆ (3 or 5 position ) in the phenyl ring compared to the first blocked developer, and/or (iii) at least one carbon is removed from an existing ring substituent R₁, R₂, R₃, R₄ such that the final ring substituents are asymmetric with respect to the nitrogen-nitrogen axis in Structure III.

3. The process of claim 1 wherein, with respect to DEV for the second blocked developer, R₅ and R₆ in Structure III are independently hydrogen or a substituted or unsubstituted alkyl group or R₅ and R₆ are connected to form a ring; and
R₁, R₂, R₃, and R₄ are independently hydrogen, halogen, hydroxy, amino, alkoxy, carbonamido, sulfonamido, alkylsulfonamido or alkyl, or R₃ can connect with R₁ or R₅ and/or R₄ can connect to R₂ or R₆ to form a ring.

4. The process of claim 1, wherein DEV in the second blocked developer has the following structure: 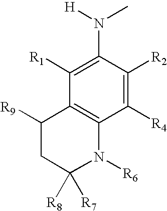
wherein R₁, R₂, R₄ and R₆ are as defined above and R₇, R₈, and R₉ can independently be any of the same substituents as R₁.

5. The process of claim 1, wherein, with respect to DEV for the second blocked developer, at least one of R₁ and R₂ is a substituted or unsubstituted alkyl or alkoxy or an alkylsulfonamido; R₃ and R₄ are hydrogen; and R₅ and R₆ are independently hydrogen or a substituted or unsubstituted alkyl group or R₅ and R₆ are connected to form a ring.

6. The process of claim 1, wherein the first and second blocked developer independently are represented by the following structure: 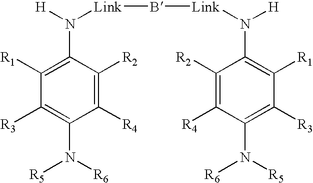
wherein R₁ through R₆ is as defined above, LINK is as defined for LINK1 and B is an organic moietythat is a common blocking group, between linking groups, for the releasable developing agents.

7. The process of claim 1, wherein the first and second blocked developer are dispersed by milling an aqueous slurry of the first and second blocked developers.

8. The process of claim 1, wherein the first blocked developer and second blocked developer are dispersed by precipitating the first and second blocked developer from solution.

9. The process of claim 1 wherein the first blocked developer is a blocked developer useful in photothermographic elements.

10. The process of claim 1, wherein the structurally similar distinct firs and second blocked developers each comprise an identical structural section thereof which makes up at least 75% of the total molecular weight of the first blocked developer.

11. The process of claim 1, wherein the structurally similar distinct first and second blocked developers each comprise an identical structural section thereof which makes up at least 90% of the total molecular weight of the first blocked developer.

12. The process of claim 1, wherein the second blocked developer is present in the dispersion at from between 0.05 to 50 wt % of the first blocked developer or vice versa.

13. The process of claim 12, wherein the second blocked developer is present in the dispersion at less than 20 wt % of the first block developer or less or vice versa.

14. The process of claim 1, wherein the second blocked developer is present in the dispersion at 0.5 wt % or greater of the first blocked developer or vice versa.

15. A composition comprising a stable solid particle dispersion of solid particles of a first blocked developer useful in imaging elements and from 0.05 to 50 wt %, based on the weight of the first blocked developer, of a structurally similar distinct additive in the form of a second blocked developer, dispersed together in an aqueous medium, wherein both the first blocked developer and the second blocked developer independently have the following Structure I:
DEV-(LINK 1)ₗ-(TIME)ₘ-(LINK 2)ₙ-B I
wherein,
DEV is a phenylene diamine moiety as defined below which when released forms a color developing agent:
LINK 1 and LINK 2 are linking groups;
TIME is a timing group;
l is 0 or 1;
m is 0, 1, or 2;
n is 0 or 1;
l+n is 1 or 2;
B comprises a second phenylene diamine moiety DEV and is represented by the following structure:
-B′-(LINK 2)ₙ-(TIME)ₘ-(LINK 1)ₗ-DEV
wherein B′ is a common blocking group for both DEV moieties;
wherein LINK 1 or LINK 2 are independently of Structure II: 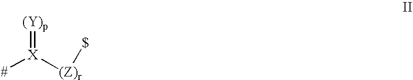
wherein
X represents carbon or sulfur;
Y represents oxygen, sulfur of N—R₁, where R₁ is substituted or unsubstituted alkyl or substituted or unsubstituted aryl;
p is 1 or 2;
Z represents carbon, oxygen or sulfur;
r is 0 or 1;
with the proviso that when X is carbon, both p and r are 1, when X is sulfur, Y is oxygen, p is 2and r is 0;
# denotes the bond to PUG (for LINK 1) or TIME (for LINK 2):
$ denotes the bond to TIME (for LINK 1) or T₍ₜ₎ substituted carbon (for LINK 2); and
wherein DEV in the second blocked developer is independently represented by the following structure: 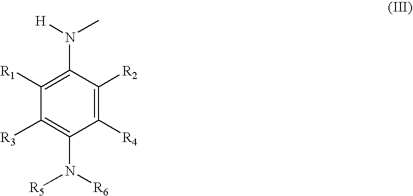
wherein R₁, R₂, R₃, R₄, R₅ and R₆ which can be the same or different are individually H, alkyl, substituted alkyl, alkenyl, substituted alkenyl, aryl, substituted aryl, halogen, cyano, hydroxy, alkoxy, substituted alkoxy, aryloxy, substituted aryloxy, amino, substituted amino, alkylcarbonamido, substituted alkylcarbonamido, arylcarbonamido, substituted arylcarbonamido, alkylsulfonamido, arylsulfonamido, substituted alkylsulfonamido, substituted arylsulfonamido, or sulfamyl or wherein at least two of R₁, R₂, R₃, R₄, R₅ and R₆ together further form a substituted or unsubstituted carbocyclic or heterocyclic ring structure or wherein R₅ or R₆ can optionally form a fused ring with R₃ or R₄, respectively on the phenylene ring; and
wherein the first blocked developer independently is represented by Structure III except that R₅ is the same as R₆ and both are alkyl groups and wherein the DEV in the first blocked developer is the same as the DEV in the second blocked developer except either (a) differs with respect to R₅ and/or R₆ and/or (b) differs by the number of carbons in any one or more substituents R₁, R₂, R₃, R₄ on the phenylene ring in Structure III.

16. The composition of claim 15 wherein in the second blocked developer either
(a) R₅ is not R₆ and the difference between at least one of R₅ and R₆ in the second blocked developer, respectively, with respect to R₅ and R₆ in the first developer is the addition of at least 1 carbon, or wherein R₅ or R₆ in the second blocked developer forms a fused ring with the phenyldiamine ring in Structure III; with the proviso (i) that if a heteroatoms is present in R₅ or R₆ in the second blocked developer, then no hydrogen is attached to the heteroatom; and with the additional proviso (ii) that R₅ and R₆ in the second blocked developer do not form a ring that is symmetrical around an axis connecting both nitrogens in Structure III; and/or
(b) at least one carbon is added to an existing ring substituent R₁, R₂, R₃, or R₄ compared to the R₁, R₂, R₃, R₄ in first blocked developer, or (ii) at least substituent having at least one carbon is added to a ring carbon vicinal to the —NR₅R₆ (3 or 5 position ) in the phenyl ring compared to the first blocked developer, and/or (iii) at least one carbon is removed from an existing ring substituent R₁, R₂, R₃, R₄ such that the final ring substituents are asymmetric with respect to the nitrogen-nitrogen axis in Structure III.

17. The composition of claim 15 wherein, with respect to DEV for the second blocked developer, R₅ and R₆ in Structure III are independently hydrogen or a substituted or unsubstituted alkyl group or R₅ and R₆ are connected to form a ring; and
R₁, R₂, R₃, and R₄ are independently hydrogen, halogen, hydroxy, amino, alkoxy, carbonamido, sulfonamido, alkylsulfonamido or alkyl, or R₃ can connect with R₁ or R₅ and/or R₄ can connect to R₂ or R₆ to form a ring;

18. The composition of claim 15, wherein DEV in the second blocked developer has the following structure: 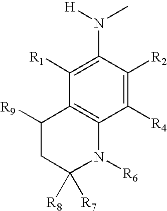
wherein R₁, R₂, R₄ and R₆ are as defined above and R₇, R₈, and R₉ can independently be any of the same substituents as R₁.

19. The composition of claim 15, wherein, with respect to DEV for the second blocked developer, at least one of R₁ and R₂ is a substituted or unsubstituted alkyl or alkoxy or an alkylsulfonamido; R₃ and R₄ are hydrogen; and R₅ and R₆ are independently hydrogen or a substituted or unsubstituted alkyl group or R₅ and R₆ are connected to form a ring.

20. The composition of claim 15, wherein the first and second blocked developer independently are represented by the following structure: 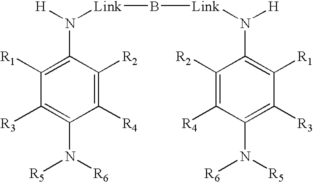
wherein R₁ through R₆ is as defined above, LINK is as defined for LINK1 and B is an organic substituent that is a common blocking group.

21. The composition of claim 15, wherein the solid particle dispersion has an average particle size of less than one micron.

22. The composition of claim 15 wherein the second blocked developer upon release is the neutral or photographically acceptable salt form of the compound represented by the following Structure IV: 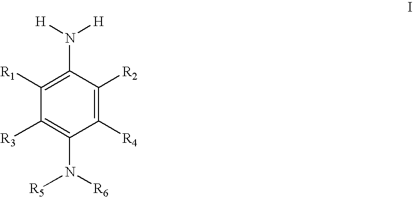
wherein R¹, R², R³, R⁴, R⁵ and R⁶ are as defined above.

23. The composition of claim 15 wherein the first blocked developer is represented by the following structure: 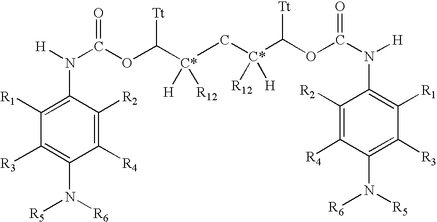
wherein R₁ through R₆ is as defined above for the first blocked developer and wherein:
C* is tetrahedral (sp³ hybridized) carbon;
R₁₂ is hydrogen, or a substituted or unsubstituted alkyl, cycloalkyl, aryl or heterocyclic group;
T is independently selected from a substituted or unsubstituted, referring to the following T groups, alkyl group, cycloalkyl group, aryl, or heterocyclic group, an inorganic monovalent electron-withdrawing group, or an inorganic divalent electron withdrawing group capped with at least one C1 to C10 organic group; or T is joined with R₁₂ to form a ring; or two T groups can combine to form a ring; and
t is a subscript that is 0, 1, or 2, wherein when t is not 2, the necessary number of hydrogens (2-t) are present in the structure.

24. The composition of claim 15 wherein both blocked developers are independently represented by the following Structure: 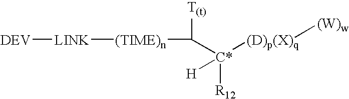
wherein:
DEV for each blocked developer is as defined above;
LINK is a linking group as defined above for LINK1;
TIME is a timing group;
n is 0, 1, or 2;
t is 0, 1, or 2, and when t is not 2, the necessary number of hydrogens (2-t) are present in the structure;
C* is tetrahedral (sp³ hybridized) carbon;
p is 0 or 1;
q is 0 or 1;
w is 0 or 1;
p+q=1 and when p is 1, q and w are both 0; when q is 1, then w is 1;
R₁₂ is hydrogen, or a substituted or unsubstituted alkyl, cycloalkyl, aryl or heterocyclic group or R₁₂ can combine with W to form a ring;
T is independently selected from a substituted or unsubstituted, referring to the following T groups, alkyl group, cycloalkyl group, aryl, or heterocyclic group, an inorganic monovalent electron withdrawing group, or an inorganic divalent electron withdrawing group capped with at least one C1 to C10 organic group (either an R₁₃ or an R₁₃ and R₁₄ group); or T is joined with W or R₁₂ to form a ring; or two T groups can combine to form a ring;
D is a first activating group selected from substituted or unsubstituted (referring to the following D groups) heteroaromatic group or aryl group or monovalent electron withdrawing group, wherein the heteroaromatic can optionally form a ring with T or R₁₂;
X is a second activating group and is a divalent electron-withdrawing group;
W is a group represented by the following Structure IA: 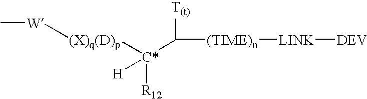
W′ is independently selected from a substituted or unsubstituted (referring to the following W′ groups) alkyl, cycloalkyl, aryl or heterocyclic group; and wherein W′ in combination with T or R₁₂ can form a ring;
R₁₃ , R₁₄, R₁₅ , and R₁₆ can independently be selected from substituted or unsubstituted alkyl, aryl, or heterocyclic group;
any two members of the following set: R₁₂, T, and either D or W, that are not directly linked may be joined to form a ring.

25. The composition of claim 24, where LINK has the following structure:

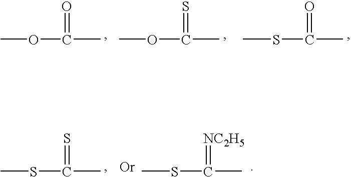

26. The composition of claim 25 wherein LINK is

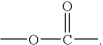

27. A photographic element comprising a support bearing at least one silver halide emulsion layer, and at least one layer, which may be the same as or different from the silver halide emulsion layer, which comprises a dispersion according to claim 15.
